(19) United States
(12) Patent Application Publication
(10) Pub. No.: US 2018/0004234 A1
(43) Pub. Date: Jan. 4, 2018

(54) FUZZY LOGIC FLOW REGIME IDENTIFICATION AND CONTROL

(71) Applicant: LANDMARK GRAPHICS CORPORATION, Houston, TX (US)

(72) Inventors: Serkan DURSUN, Missouri City, TX (US); Florentina POPA, Houston, TX (US); Brent Charles HOUCHENS, Houston, TX (US)

(21) Appl. No.: 15/545,282

(22) PCT Filed: Jul. 27, 2015
(86) PCT No.: PCT/US2015/042256

§ 371 Date: Jul. 20, 2017

Related U.S. Application Data
(60) Provisional application No. 62/138,117, filed on Mar. 25, 2015.

(51) Int. Cl. G05D 7/06; G05B 15/02; G01V 9/00; E21B 49/08; E21B 43/34; E21B 43/12; G06N 7/02; E21B 34/06

(52) U.S. Cl. CPC G05D 7/0635; G06N 7/02; G05D 7/0605; G05B 15/02; E21B 34/06; E21B 49/08; E21B 43/34; E21B 43/121; G01V 9/00

(57) ABSTRACT

In some embodiments, an apparatus and a system, as well as a method and article, may operate to identify one or more multiphase fluid flow regimes as an output of fuzzy logic processing, with inputs to the fuzzy logic processing comprising a set of physical parameter values as attributes at a location in a fluid flow that are determined by at least one of measurement or simulation, and to operate a controlled device based on the output. Additional apparatus, systems, and methods are disclosed.

### CROSS-REFERENCE TO RELATED APPLICATIONS

The present application claims the benefit of priority to provisional application Ser. No. 62/138,117, filed Mar. 25, 2015, which is incorporated herein by reference in its entirely.

### BACKGROUND

Understanding the structure and properties of the physical world can reduce the cost of operations on the factory floor, and in the field. For example, knowing the characteristics of geological formations can lessen the cost of drilling wells for oil and gas exploration. Measurements made in a borehole (i.e., downhole measurements) are typically performed to attain this understanding, to identify the composition and distribution of material that surrounds the measurement device downhole. Sometimes this material is present in more than one phase, such as liquid and gas, or fluid of one composition, and fluid of another composition.

The state in which a multiphase system exists may be defined by multiple regimes, which are in turn determined by a set of fundamental, independent parameters. These independent parameters are physical variables, continuous by definition, within their space. Each regime may be further described by one or more descriptive parameters, functions, data sets and/or empirical correlations, some of which may provide useful insight into the behavior of the system, but which are not necessarily part of the fundamental, independent parameter space.

Flow regime identification via mechanistic arguments is formally valid only at equilibrium conditions. The mechanistic arguments are inherently deterministic, though real multiphase flow systems depend on initial conditions and some regimes exhibit stochastic behavior. Furthermore, in real multiphase systems, the transitions between flow regimes require a finite amount of time, and thus, some sections of the flow may exist in non-equilibrium states.

### BRIEF DESCRIPTION OF THE DRAWINGS

FIG. 1 is an example data structure that may be used to assign attributes to a flow regime, according to various embodiments.

FIG. 2 is a workflow diagram for flow regime identification, according to various embodiments.

FIG. 3 is a workflow design for regime identification and pressure drop prediction, according to various embodiments of the invention.

FIG. 4 is a workflow diagram for pressure drop prediction, according to various embodiments.

FIG. 5 is a table that includes some example multiphase flow systems for internal flows of immiscible fluids, with or without solids loading, according to various embodiments.

FIG. 6 is a flow-regime map for air and water at 20° Celsius (C) and 1 atmosphere (atm) in vertical upward flow in a 0.8 m diameter pipe based on mechanistic models and an associated conditional flowchart, according to various embodiments.

FIGS. 7A-7E are a series of flow-regime surfaces for air and water at 20° C. and 1 atm in vertical upward flow in a 0.8 m diameter pipe based on fuzzy logic, according to various embodiments.

FIG. 8 illustrates a membership function for the superficial gas velocity attribute, according to various embodiments.

FIG. 9 illustrates a membership function for the superficial liquid velocity attribute, according to various embodiments.

FIG. 10 illustrates a membership function for the dispersed bubble flow regime output, according to various embodiments.

FIG. 11 illustrates a membership function for the bubbly flow regime output, according to various embodiments.

FIG. 12 illustrates a membership function for the slug flow regime output, according to various embodiments.

FIG. 13 illustrates a membership function for the churn flow regime output, according to various embodiments.

FIG. 14 illustrates a membership function for the annular flow regime output, according to various embodiments.

FIG. 15 illustrates an example of fuzzy logic (fuzzy inference system) processing using two input attributes and five output flow regimes, according to various embodiments.

FIG. 16 illustrates a control apparatus, and a control system according to various embodiments.

FIG. 17 is a flow diagram illustrating methods of identifying regimes, and smoothing discontinuities between them, according to various embodiments.

FIG. 18 illustrates an example wireline system, according to various embodiments.

FIG. 19 illustrates an example drilling rig system, according to various embodiments.

FIG. 20 illustrates a membership function for input variable v_{SG}, with an example of crisp to fuzzified input conversion, according to various embodiments.

FIG. 21 illustrates a membership function for input variable v_{SL}, according to various embodiments.

FIG. 22 illustrates a membership function for input variable θ, according to various embodiments.

FIG. 23 illustrates a typical membership function for output flow regimes, according to various embodiments.

FIG. 24 illustrates a mechanistic and fuzzy regime map prediction for θ=90° of air and water at 20° C. and 1 atm in 0.1 m diameter smooth pipe, according to various embodiments.

FIG. 25 illustrates a mechanistic and fuzzy regime map prediction for θ=0° (horizontal flow) of air and water at 20° C. and 1 atm in 0.1 meter (m) diameter smooth pipe, according to various embodiments.

FIG. 26 illustrates a mechanistic and fuzzy regime map prediction for θ=−90° (vertical downward flow) of air and water at 20° C. and 1 atm in 0.1 m diameter smooth pipe, according to various embodiments.

FIG. 27 illustrates a mechanistic and fuzzy regime map prediction for θ=45° (inclined upward flow) of air and water at 20° C. and 1 atm in 0.1 m diameter smooth pipe, according to various embodiments.

FIG. 28 illustrates a mechanistic and fuzzy regime map prediction for θ=−45° (inclined downward flow) of air and water at 20° C. and 1 atm in 0.1 m diameter smooth pipe, according to various embodiments.

FIG. 29 illustrates discrete pressure drop values for regimes predicted by the mechanistic model for the flow of air and water at 20° C. and 1 atm in a 0.1 m diameter smooth pipe inclined vertically upward at θ=90°, for v_{SL}=0.1 meter per second (m/s), according to various embodiments.

FIG. 30 illustrates crisp outputs from the fuzzy system for the flow of air and water at 20° C. and 1 atm in a 0.1 m diameter smooth pipe inclined vertically upward at θ=90°, for v_{SL}=0.1, according to various embodiments.

FIG. 31 illustrates pressure drop values for regimes predicted by the fuzzy system compared with discrete values for regimes predicted by the mechanistic regime model for the flow of air and water at 20° C. and 1 atm in a 0.1 m diameter smooth pipe inclined vertically upward at θ=90°, for v_{SL}=0.1 m/s, according to various embodiments.

### DETAILED DESCRIPTION

As noted previously, the existence of a multiphase flow can result in multiple regimes. The characterization of transitions between regimes becomes a major challenge for existing simulators and control systems when discontinuities arise. As a result, the flow regime predicted by mechanistic models can switch abruptly with only a small change in flow parameters. In reality, these changes take finite time to develop, and may exhibit hysteresis.

In an attempt to address this problem, some software tools implement a global approximation to remove discontinuities, which introduces global error and a loss of accuracy everywhere in the domain, even at a distance from the discontinuities. Other systems retain the discontinuities at some level, to reduce global error over most of the domain, but fail to function appropriately (or at all) when the remaining discontinuities are encountered.

To address some of these challenges, as well as others, apparatus, systems, and methods are described herein that operate to apply fuzzy logic to identify and control the flow of multiphase systems. For example, fuzzy logic can be used to mimic the effects of multiphase flow through the partial degree of membership feature. As a result, fuzzy logic can provide smoother control to electro-mechanical systems when compared to control based purely on mechanistic models.

The technical solution provided by various embodiments herein is therefore to design a workflow using a fuzzy inference system (FIS) for building surrogate modeling (as a proxy) to predict the flow regime pattern and pressure drop in pipelines and other contained flows. These predictions can be used, in turn, to control and maintain the flow of oil in a pipeline, for example.

Regime identification via fuzzy logic can be useful when it provides broader transition zones between regimes via weighting functions, to better simulate reality. In addition, the resulting smoothed weighting functions can provide a method for improved control over electro-mechanical systems that are placed in-line to respond to changes in flow regimes. Moreover, the use of fuzzy logic is computationally efficient, dramatically improving the speed of the processing unit that implements it.

In some embodiments, methods offer a dynamic approach to flow pattern identification by allowing the addition or removal, and/or range extension of input parameters, as well as the addition of new flow regimes. Additionally, more accurate flow regime identification can be obtained.

In many embodiments, the use of trained fuzzy logic provides a computational robustness and speed for control various systems, to realize real-time control. Once implemented, a fuzzy logic controller that operates according to the methods described herein does not need to evaluate closure relations, which are known to exhibit discontinuities and can produce non-physical results when applied over a broad range of conditions. Thus, the controller as a technical solution can respond more quickly and with more robust calculation capability. Electro-mechanical systems coupled to the controller will thus experience more optimal control, reducing the possibility of oscillations between regimes and the associated detrimental effects, such as vibrations, slugging, and gas-locking. Finally, the use of fuzzy logic control can operate electro-mechanical systems so that flow conditions are maintained, to produce a desired flow regime. In order to provide this type of FIS modeling, the data representing various regime patterns should first be generated, or retrieved directly from experimental observations.

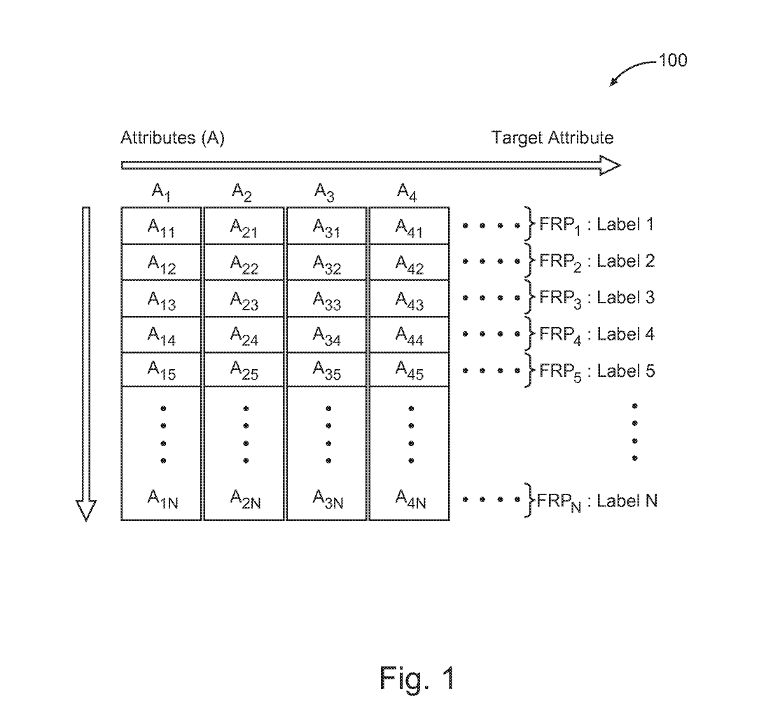

FIG. 1 is an example data structure 100 that may be used to assign attributes to a flow regime, according to various embodiments. This is a table with n columns and Σmᵢ rows, where n is the number of input parameters and mᵢ is distributed among the range of values that each attribute can take in a given flow regime. As an example, the first five rows of the structure 100 can be used to characterize a flow regime when all attributes but A1 are held constant. In this scenario five represents the number of possible values that attribute A1 can take from its range of definition. The following five rows would correspond to varying attribute A1 when the values of all the other attributes are held constant, and attribute A2 was assigned a new possible value from its own range. The combinations are exhausted when all the ranges for all of the attributes are included. Those of ordinary skill in the art are familiar with the range of characteristic values that may be assigned to various flow regimes. Thus, each attribute value, corresponding to each flow regime to be identified, may be determined via simulation, or observation, and entered into the structure 100.

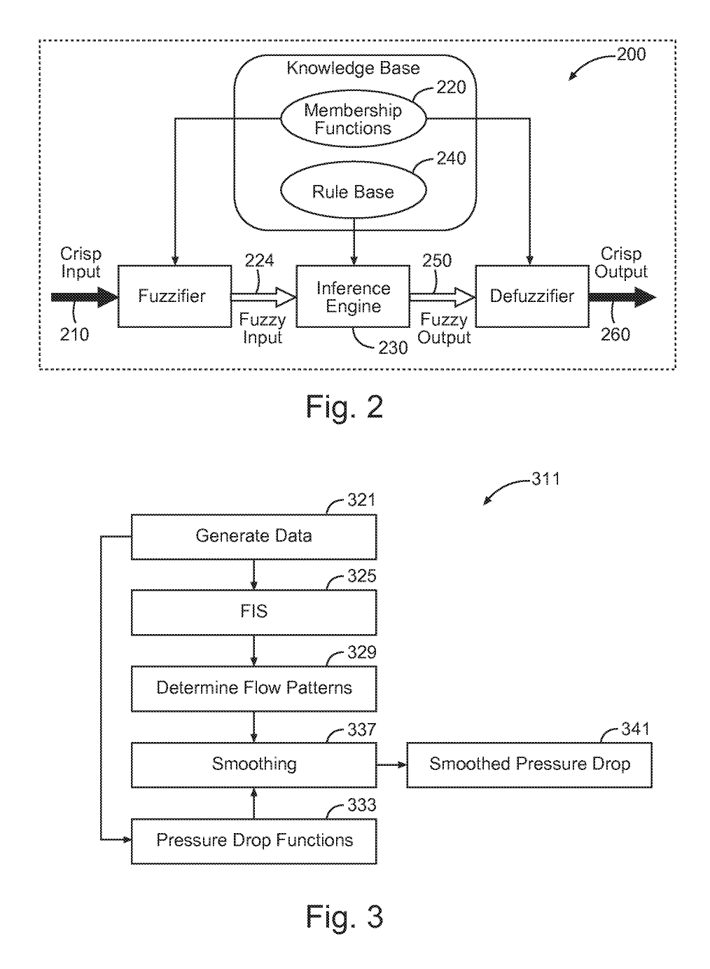

FIG. 2 is a workflow diagram 200 for flow regime identification, according to various embodiments. Here input attributes (e.g., parameters, such as liquid density, gas density, etc.) 210 and fuzzy membership functions 220 for each flow pattern have been generated, based on their physical value ranges and possible position relative to a given regime, respectively. A fuzzy inference engine 230 driven by logical (e.g., if-then) statements called “rules” in a rule base 240 is then used to compute the fuzzy output 250 (e.g., flow patterns) from the fuzzy input 224. After applying a defuzzification operation, the fuzzy output 250 is transformed into a quantifiable result which in this case are values 260 that indicate the position in a flow regime. The highest value of crisp output φ gives the flow regime rendered by a set of attributes, whereas the smaller values φ weighted by

$$\frac{1 - {φ}_{k}}{{\sum }_{j \neq k} {φ}_{j}}$$

gives the proximity of the neighbors. Here φ stands for the crisp output value of membership, with k being an index that corresponds to the highest value of membership in the flow regime, and j being an index corresponding to the membership value in all other regimes.

FIG. 3 is a workflow 311 design for regime identification and pressure drop prediction, according to various embodiments of the invention. Regime identification and pressure drop determination are both useful. For example, in some embodiments, a controlled change in operating conditions can be made to avoid an identified regime, or the pressure drop can be used to determine when to turn on a valve.

To build a fuzzy model, the following approach may thus be used. At block 321, crisp input data is generated. This can be divided into a series of tasks, including defining input parameters, specifying the value range of input parameters, generating values of input attributes in the specified ranges, applying the input parameters to mechanistic models to predict the corresponding flow patterns (or use experimental observations to supply these values), and finally, pair the input parameter values with flow patterns.

Continued activity at block 321 may include calculating the distribution of the values for each input parameter leading to each flow pattern. The result of this task gives an indication of flow pattern sensitivity to the different input parameters, to assist in devising class membership functions.

At block 325, fuzzy class membership functions can be defined. Domain expertise is used to devise the class membership functions that are assigned with different linguistic variables, such as very low (VL), low (L), medium (M), and high (H). The membership functions can, for example, map the parameter ranges to a membership value between 0 and 1. The number and/or parameters of the membership functions used for each input parameter depend on the sensitivity of the flow regimes to that parameter. Thus, more membership functions may be used to capture high sensitivity situations.

Continued activity at block 325 may include defining the fuzzy inference engine rules. Here the rules can be expressed as logical statements of one or more fuzzified input parameters and the fuzzified outputs. “AND” and “OR” can be used as logical operators and treated as min and max function of two or more membership classes, respectively.

At block 329, the flow patterns can be predicted, with associated weights. Once one or more regimes have been identified at a particular location, operating conditions at that location may be controlled, based on the identified regimes. For example, operating conditions might be controlled to avoid a particular identified regime (e.g., avoiding slug flow).

Every flow regime is assigned using a membership function. Due to overlapping membership functions, a point in the input space can indicate partial memberships for more than one of the linguistic variables that is used to partition an attribute.

At block 333, appropriate pressure drop functions corresponding to flow patterns that have been predicted can be implemented according to the equilibrium regime membership. These functions are well known to those of ordinary skill in the art. Others that desire more information can refer to various references in the literature, such as those directed to explaining pressure drop functions based on momentum equations, including “Unified Mechanistic Model for Steady-State Two-Phase Flow: Horizontal to Vertical Upward Flow”, by Gomez, L. E., et al., SPE Journal, 5(3), 2000.

At block 337, and last, smoothing can be applied to the pressure drop function output by using the weights determined in association with the flow patterns predictions. The equation can be used to accomplish this task:

$$\frac{dP}{dx} = {\sum }_{i} {φ}_{i} \frac{dP}{dx} {\vert}_{i}$$

where the pressure drop dP is determined by the weighted class membership for a designated flow, provided the pressure drop functions are truncated for boundedness. Thus, referring to the example at hand and using the weighting procedure described above, φ₁=0.802 gives the crisp output value of membership in the bubbly regime, φ₂=0.097 gives membership in the slug flow regime, φ₃=−0.0506 gives membership in the churn flow regime, φ₄=0.0437 gives membership in the dispersed bubble regime, and φ₅=0.0068 gives membership in the annular flow regime.

In another example, if a flow regime membership is determined to be 90% “slug” and 10% “churn”, then φ₁=0.90 when i=“slug”, and φ₁=0.10 when i=“churn”. The smoothed pressure drop can be used to determine when to turn on a valve, for example. The end result, which is the smoothed pressure drop value dP/dx, is provided at block 341.

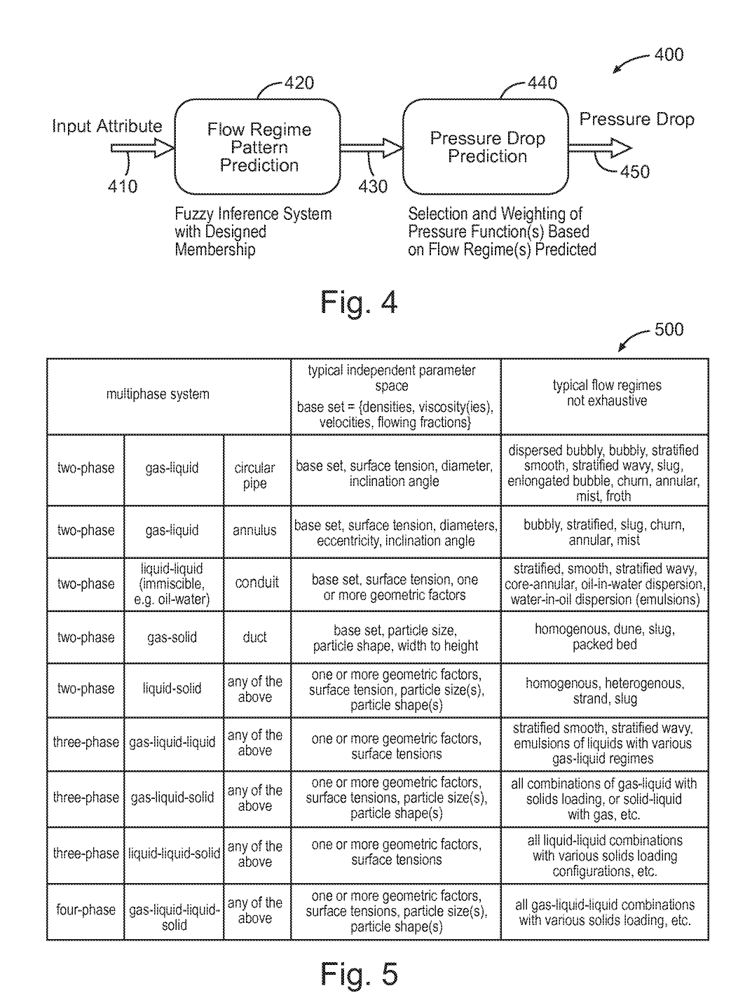

FIG. 4 is a workflow diagram 400 for pressure drop prediction, according to various embodiments. This diagram 400 can be seen as a different way to view the division of activity shown in FIG. 3. That is, input attributes 410 are fed into a flow regime pattern prediction block 420, which makes use of a FIS that is driven by membership functions to provide predicted flow patterns 430. These patterns 430 are fed into a pressure drop prediction block 440, which provides a pressure drop prediction 450 as output, driven by the selection and weighting of pressure drop functions.

FIG. 5 is a table 500 that includes some example multiphase flow systems for internal flows of immiscible fluids, with or without solids loading, according to various embodiments. These systems are just a few of many that could be listed. Those of ordinary skill in the art will be familiar with others. Thus, the parameters and flow regimes that are listed in the table 500 are not exhaustive, but merely illustrative. These examples, as well as those that are not listed, can all be addressed using that apparatus, systems, and methods described herein.

Prior approaches make use of rules taken from unified mechanistic models, and support vector machine (SVM) models, to predict the flow patterns in gas-liquid flows. However, these fail to provide a practical solution for regime transition treatment. Fortunately, fuzzy logic deals with reasoning that is approximate, rather than fixed and exact. Compared to traditional binary sets where variables may take on only true or false values, fuzzy logic variables may have a truth value that ranges in degree, such as between values of 0 and 1. Fuzzy logic has been extended to handle the concept of partial truth, where a “true” value may have a range that varies between completely true and completely false. Thus, as noted previously, the application of fuzzy logic to control systems in various embodiments might be expected to provide for smooth control in the face of abrupt changes in system conditions, such as pressure drops or changes between flow regimes.

As those of ordinary skill in the art are aware, in flow transitions from one regime to another, the geometry of the flow can change dramatically. Associated with these geometric changes, descriptive features such as pressure drop and heat transfer coefficient can also change abruptly. Physical systems, such as pumps, compressors, injectors, valves, chokes, and heat exchanges therefore perform suitably over a subset of the possible multiphase regimes. Thus, it is advantageous to have fast, but smooth responses to changes in flow regimes. By coupling the fuzzy logic regime identification described above with one or more flow measurement devices, it is possible to control these physical systems to optimize their efficiencies.

One of the hallmarks of the various embodiments described is their general applicability. The methods, apparatus, and systems are relevant to any modeling where discontinuities appear due to, for example, i) insufficient descriptions of the physics or governing mechanisms used to remove any non-physical discontinuities; ii) deliberate simplification of the physics or mechanisms to yield tractable models which can be solved on reasonable time-scales; and iii) unintentional failure to capture the complete set of physical relationships that describe a particular system, resulting in unexpected discontinuities. To illustrate these points, examples of physical scenarios related to controlling devices that experience multiphase flows will now be presented.

### Example 1: Fuzzy Logic to Identify Two-Phase, Gas-Liquid Regimes in Pipe Flow with Two Input Parameters and Five Output Regimes

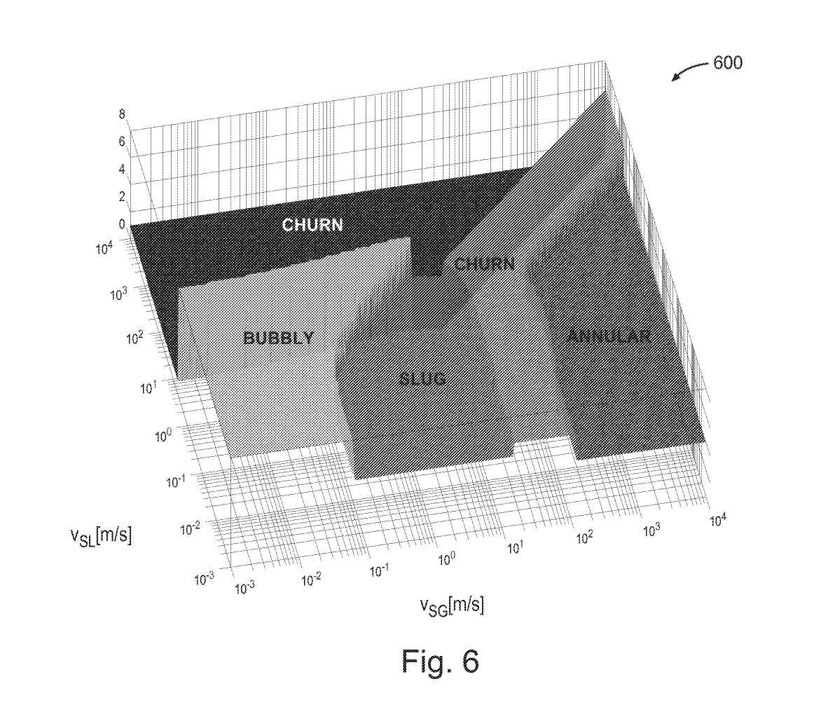

FIG. 6 is a flow-regime map 600 for air and water at 20° C. and 1 atm in vertical upward flow in a 0.8 m diameter pipe. This map 600 is based on mechanistic models and an associated conditional flowchart, according to various embodiments. Here a mechanistic workflow was implemented to generate a surface indicating the presence of various flow regimes. This map 600 is taken as a reference that fuzzy logic should be able to reproduce.

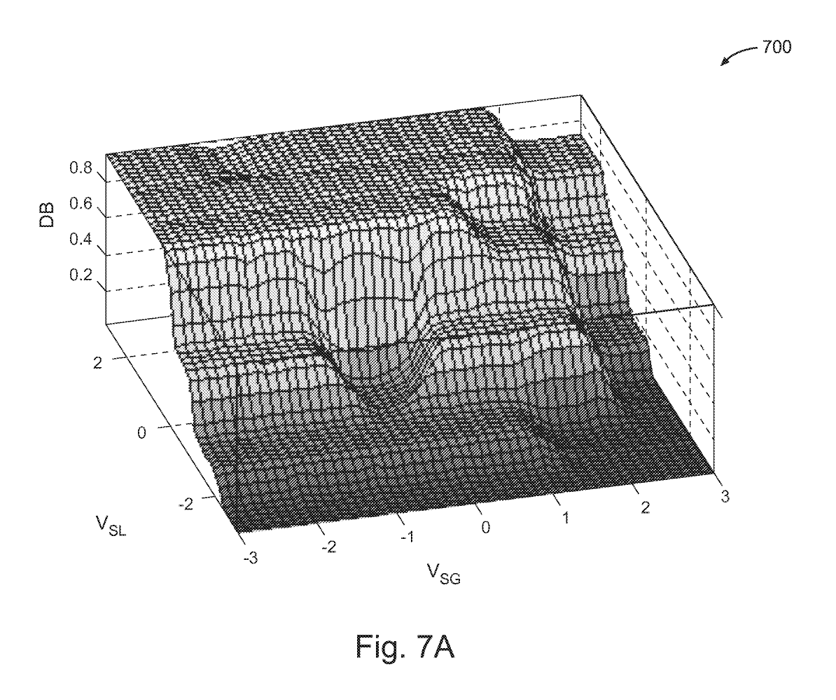

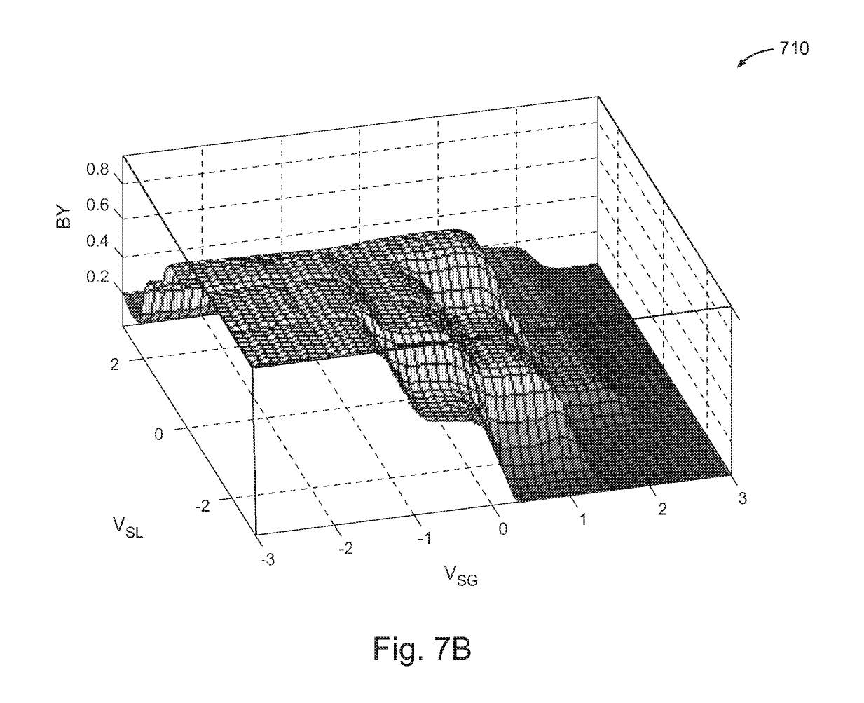

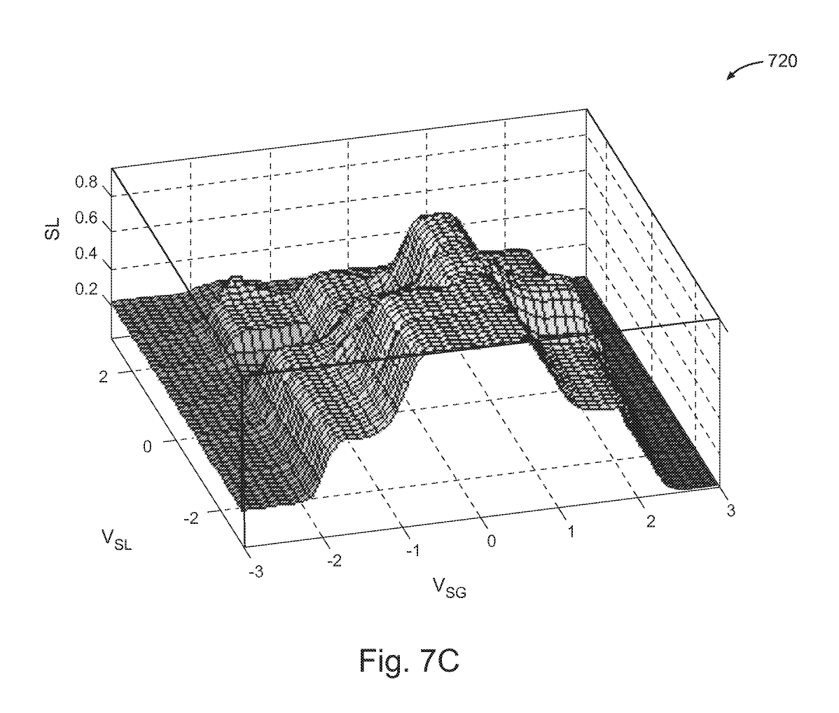

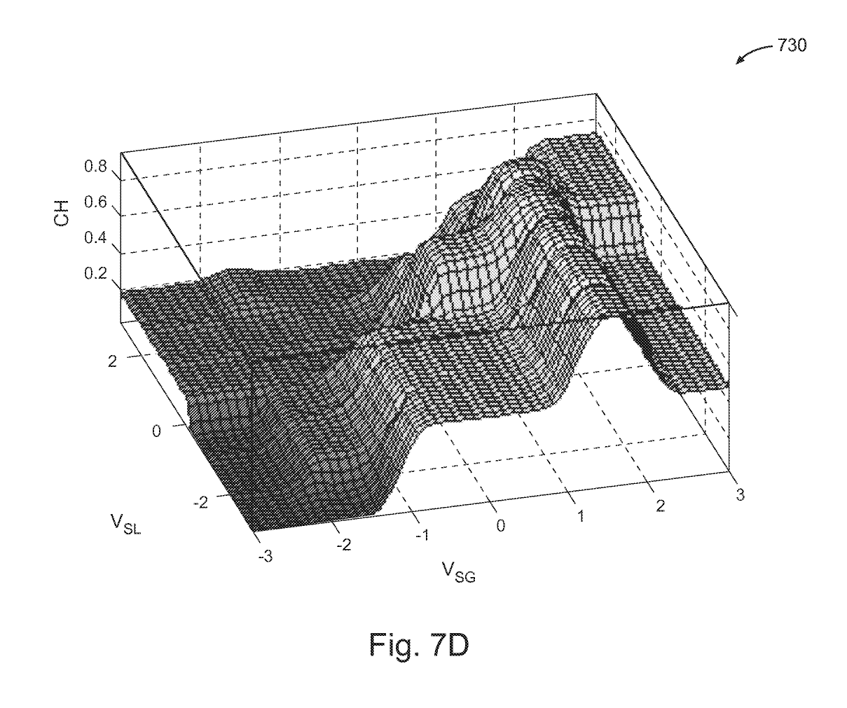

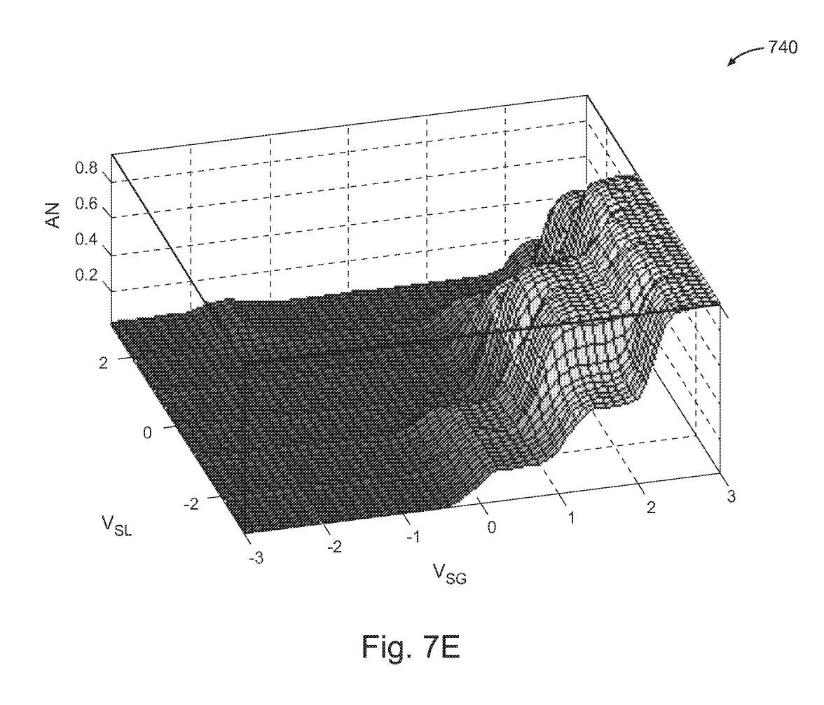

Thus, FIGS. 7A-7E are a series of flow-regime surfaces 700, 710, 720, 730, 740 for air and water at 20° C. and 1 atm in vertical upward flow in a 0.8 m diameter pipe based on fuzzy logic, according to various embodiments. The regimes identified by the fuzzy approach are shown in the surfaces 700, 710, 720, 730, 740 with different elevations. The identified flow regime in each of the FIGS. 7A-7E (i.e., DB=dispersed bubble for FIG. 7A, BY=bubbly for FIG. 7B, SL=slug for FIG. 7C, CH=churn for FIG. 7D, and AN=annular for FIG. 7E) has the highest elevation on each surface, whereas the elevation of the nearest neighboring regimes decreases with their distance from the identified flow regime. As is apparent from the figures, the fuzzy approach in FIGS. 7A-7E serves to reproduce the mechanistic regime identification of FIG. 6 quite accurately, and with greatly reduced computational time. Furthermore, smoothing between regimes is an inherent part of the fuzzy approach, and the degree of smoothness for transitions between flow regimes can be adjusted by applying weights to the inference rules. An example of fuzzy rule implementation will now be given.

A min-max approach can be used to implement logical AND-OR statements to make membership decisions, with a centroid method used for defuzzification. Membership functions assigned to the input parameters that make up the rule are thus also presented.

For example, one such rule might be stated as follows, where v_{SG}=superficial gas velocity, v_{SL}=superficial liquid velocity, ML=medium large, DB=dispersed bubble, BY=bubbly, SL=slug, and AN=annular:

IF (v_{SG} is ML) AND (v_{SL} is ML),

THEN (DB is FAR)(BY is BORDER)(SL is BORDER)(CH is CLOSE)(AN is AWAY)

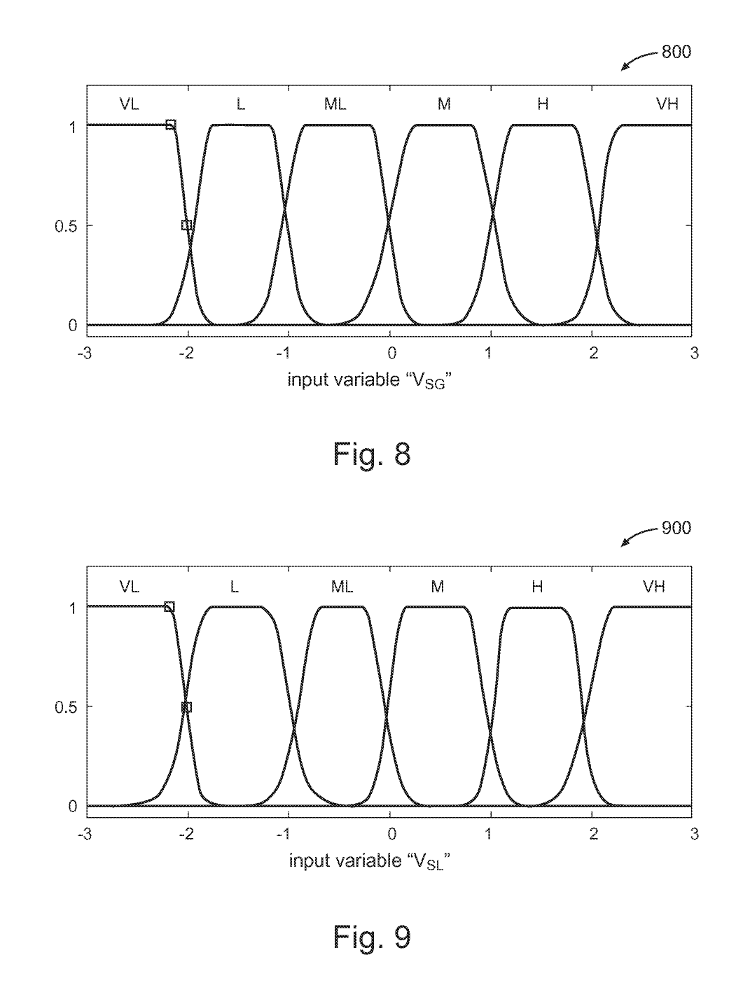

FIG. 8 illustrates a membership function 800 for the superficial gas velocity attribute, according to various embodiments. It is noted that the superficial velocities of the two phases vary over several orders of magnitude and thus, they have the greatest effect on flow pattern change among all the input parameters. Their membership functions are represented on logarithmic scales and have the following linguistic variables assigned: VL=very low, L=low, ML=medium low, M=medium, H=high, and VH=very high.

In a similar manner, FIG. 9 illustrates a membership function 900 for the superficial liquid velocity attribute, according to various embodiments.

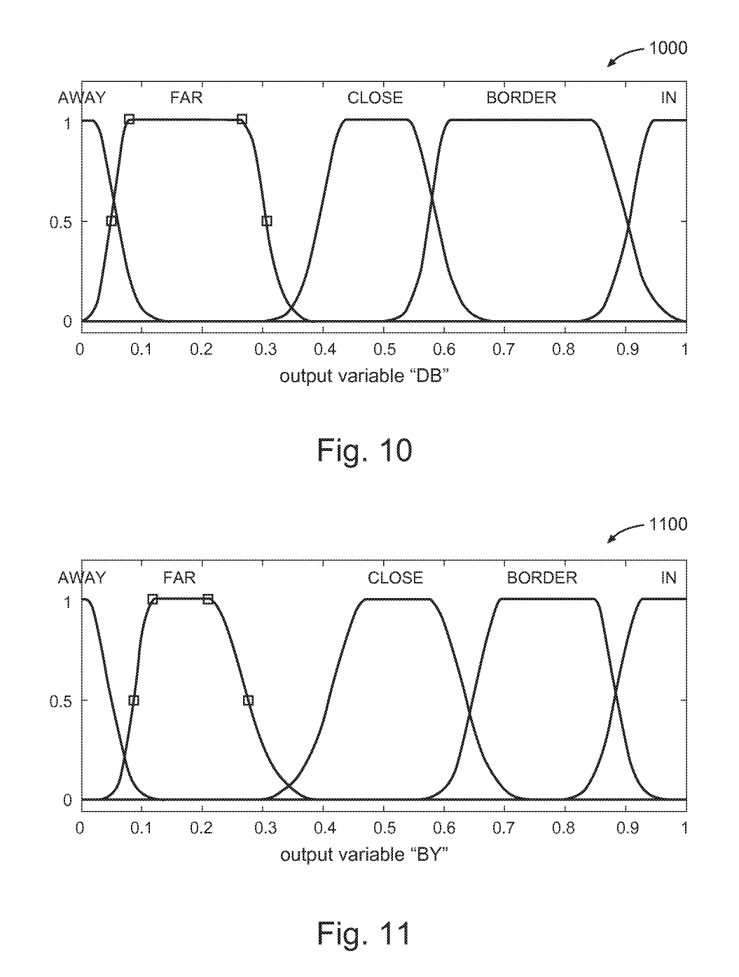

FIG. 10 illustrates a membership function 1000 for the dispersed bubble flow regime output, according to various embodiments. Here the position in the flow regime is assigned using membership functions that have the following linguistic variables: AWAY, FAR, CLOSE, BORDER, and IN. AWAY is the furthest away from the identified regime, FAR is not quite as far away as AWAY, CLOSE is closer to the identified regime than FAR, BORDER is on the border between the identified regime, and its near neighbor, and IN signifies membership only in the identified regime.

In a similar manner, FIG. 11 illustrates a membership function 1100 for the bubbly flow regime output, according to various embodiments. Here the position in the flow regime is assigned using membership functions that have the following linguistic variables: AWAY, FAR, CLOSE, BORDER, and IN. Interpretation of these variables is the same as was noted for FIG. 10.

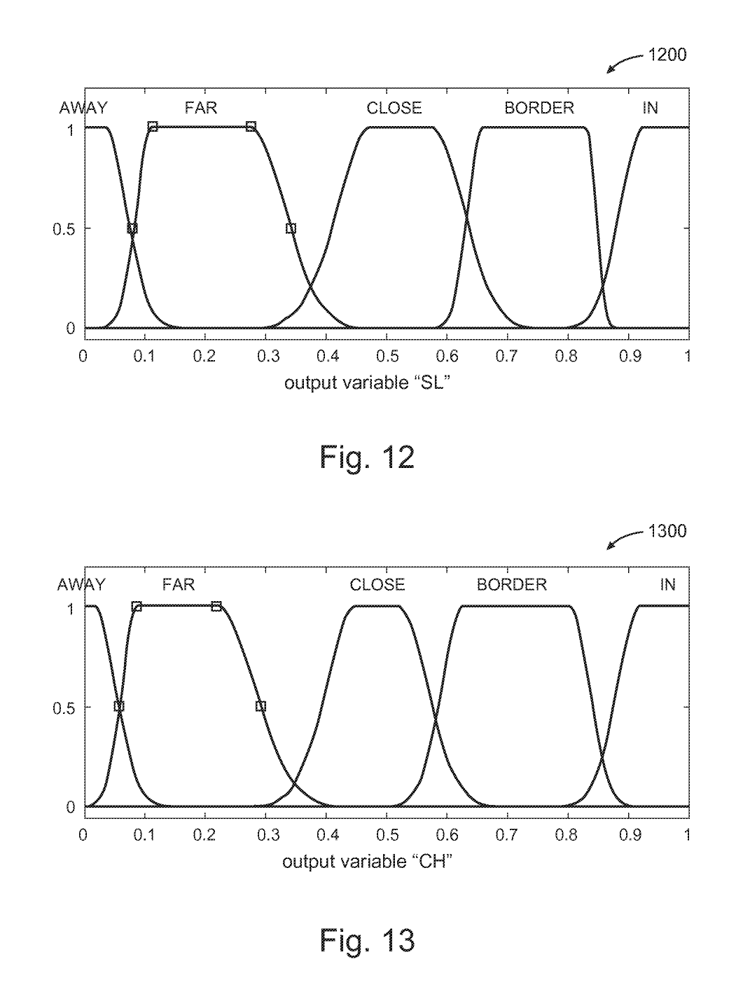

FIG. 12 illustrates a membership function 1200 for the slug flow regime output, according to various embodiments. Here the position in the flow regime is assigned using membership functions that have the following linguistic variables: AWAY, FAR, CLOSE, BORDER, and IN. Interpretation of these variables is the same as was noted for FIG. 10.

FIG. 13 illustrates a membership function 1300 for the churn flow regime output, according to various embodiments. Here the position in the flow regime is assigned using membership functions that have the following linguistic variables: AWAY, FAR, CLOSE, BORDER, and IN. Interpretation of these variables is the same as was noted for FIG. 10.

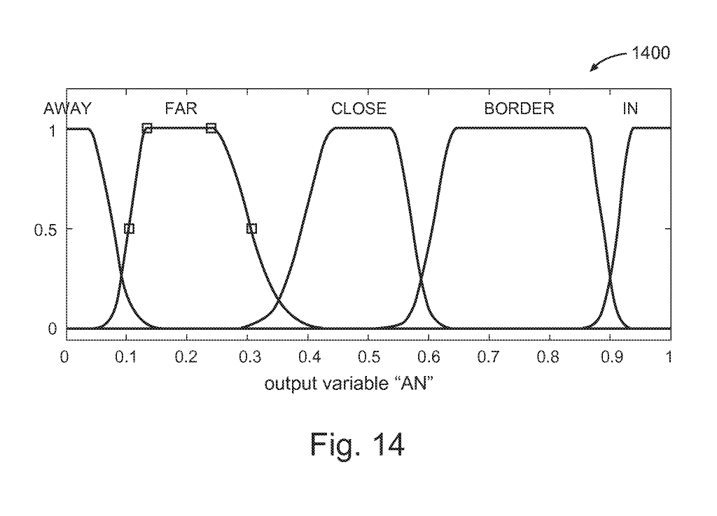

FIG. 14 illustrates a membership function 1400 for the annular flow regime output, according to various embodiments. Here the position in the flow regime is assigned using membership functions that have the following linguistic variables: AWAY, FAR, CLOSE, BORDER, and IN. Interpretation of these variables is the same as was noted for FIG. 10.

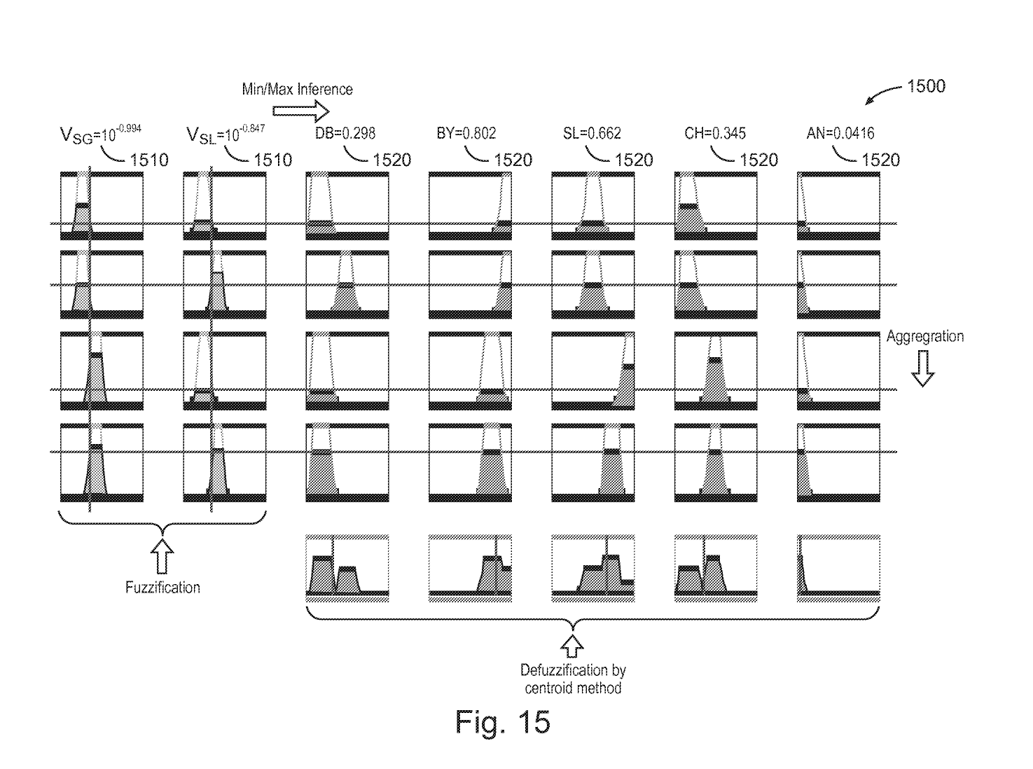

FIG. 15 illustrates an example of fuzzy logic (fuzzy inference system) processing 1500 using two input attributes 1510 and five output flow regimes 1520, according to various embodiments. For each input attribute 1510 value, the intersection of a vertical line corresponding with the crisp value to the membership function is used to indicate the values of the fuzzy input attributes 1510 between 0 and 1 to obtain the fuzzified input. Each of the logical statements containing logical operators (e.g., AND, OR, etc.) are implemented using the min/max approach. The value obtained in this way is used to make the fuzzy inference within the rule, to determine the fuzzy output. This is done by determining the intersection of a horizontal line corresponding to the value obtained by using the min/max approach to the membership functions of the outputs. This methodology is applied for all the fuzzy rules. Next, the rules are aggregated using the max approach, i.e. for the same output the maximum value is considered throughout all the rules. Finally, defuzzification is performed by applying the centroid method to the areas obtained for each output regime 1520.

### Example 2: Two-Phase Applications for Fuzzy Logic Simulation and Control Systems

Two-phase, gas-liquid flows can exist in several different flow regimes, often characterized by a geometric flow pattern. A set of independent attributes (sometimes also known as flow parameters by those of ordinary skill in the art) given in Table I determines which regime occurs at equilibrium conditions, through the use of various mechanistic arguments well known to those of ordinary skill in the art. Others that desire further information can refer to A Unified Model for Predicting Flow-Pattern Transitions for the Whole Range of Pipe Inclinations, by D. Barnea, Int. J. Multiphase Flow, 13, pp. 1-12, 1987.

TABLE I
Attributes for Two-Phase, Gas-Liquid Flows in a Circular Pipe

| Attribute | |
|---|---|
| Symbol | Attribute Description |
| ρ_{L} | liquid density |
| ρ_{G} | gas density |
| μ_{L} | liquid viscosity |
| μ_{G} | gas viscosity |
| V_{SL} | superficial liquid velocity |
| v_{SG} | superficial gas velocity |
| σ_{L} | surface tension of the liquid in contact with the gas |
| D | pipe diameter |
| θ | pipe inclination angle, measured from horizontal |
| εᵣ | pipe-wall roughness |

According to the literature, two-phase, gas-liquid flow in pipes can exist in the first eight regimes given in Table II, which in turn depend on the independent parameters shown in Table I. The single-phase and quiescent mixture regimes are also included.

TABLE II
Two-Phase, Gas-Liquid Pipe Flow Regimes and a Quiescent
Mixture

| Number | Regime | Collective Designation |
|---|---|---|
| 1 | dispersed bubble | n/a |
| 2 | stratified smooth | Stratified |
| 3 | stratified wavy | |
| 4 | annular | n/a |
| 5 | slug | Intermittent |
| 6 | churn | |
| 7 | elongated bubble | |
| 8 | bubble (also referred to as | n/a |
| | bubbly) | |
| 9 | single-phase gas | n/a |
| 10 | single-phase liquid | n/a |
| 11 | quiescent mixture | n/a |

In general, a regime may transition to many (or all) other regimes, depending on the variation of the independent parameters. However, there are at least two ways that a regime may be identified. For example, a particular regime transition function may be of type (1) necessary, but not sufficient to uniquely identify a regime, or of type (2) necessary and sufficient to uniquely identify a regime. Furthermore, the existence of a regime may be described by multiple regime transition functions, which may occur in any combination of these two scenarios. The mechanistic regime transition functions between each of the regimes are well known to those of ordinary skill in the art.

### Example 3: Integration with Physical Apparatus, Methods and Systems

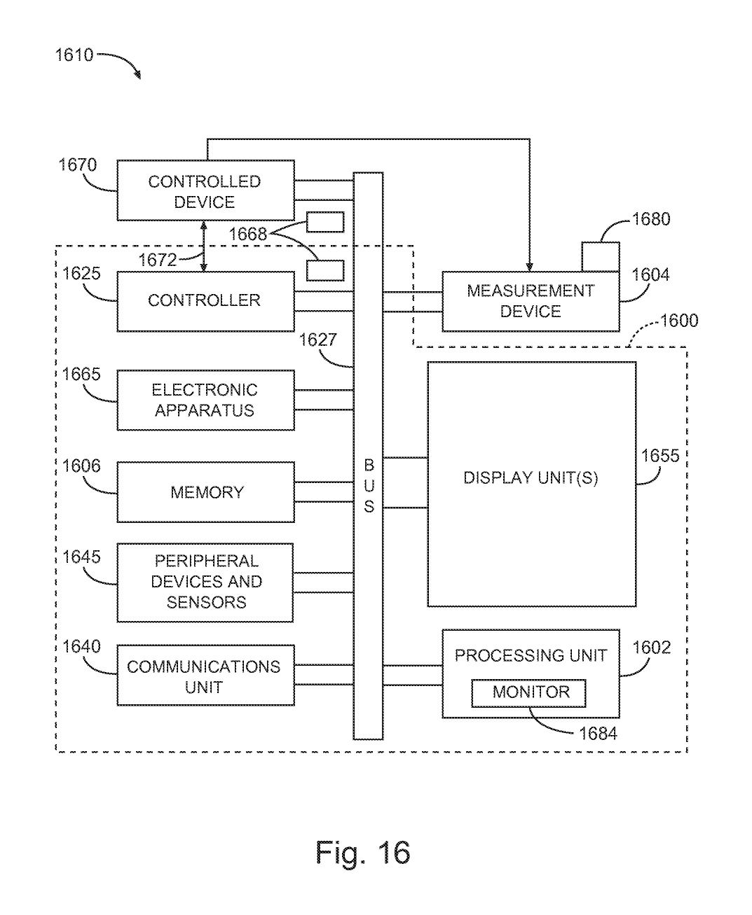

For example, FIG. 16 illustrates simulation and control apparatus 1600, and a control system 1610 according to various embodiments of the invention. The apparatus 1600 and system 1610 may form part of a laboratory flow simulator, a fluidized bed control system, a piping valve control system, and many others. In some embodiments, the apparatus 1600 and system 1610 are operable within a wellbore, or in conjunction with wireline and drilling operations, as will be discussed later.

An apparatus 1600 and system 1610 as part of a laboratory experiment, piping system, or wellbore can receive environmental measurement data via an external measurement device (e.g., a fluid parameter measurement device to measure temperature, pressure, flow velocity, and/or volume, etc.) 1604. Other peripheral devices and sensors 1645 may also contribute information to assist in the identification of flow regimes, and the simulation of various values that contribute to system operation.

A processing unit 1602 can perform fuzzy logic regime identification, among other functions, when executing instructions that carry out the methods described herein. These instructions may be stored in memory 1606. These instructions can transform a general purpose processor into the specific processing unit 1602 that can then be used to identify flow regimes, and generate control commands 1668. These commands 1668 can be supplied to a controlled device 1670 directly or indirectly. In either case, commands 1668 and/or control signals 1672 are delivered to the controlled device 1670 in such a way as to effect changes in the structure and operation of the controlled device 1670 in a predictable and smooth fashion, even as the boundaries between flow regimes are crossed.

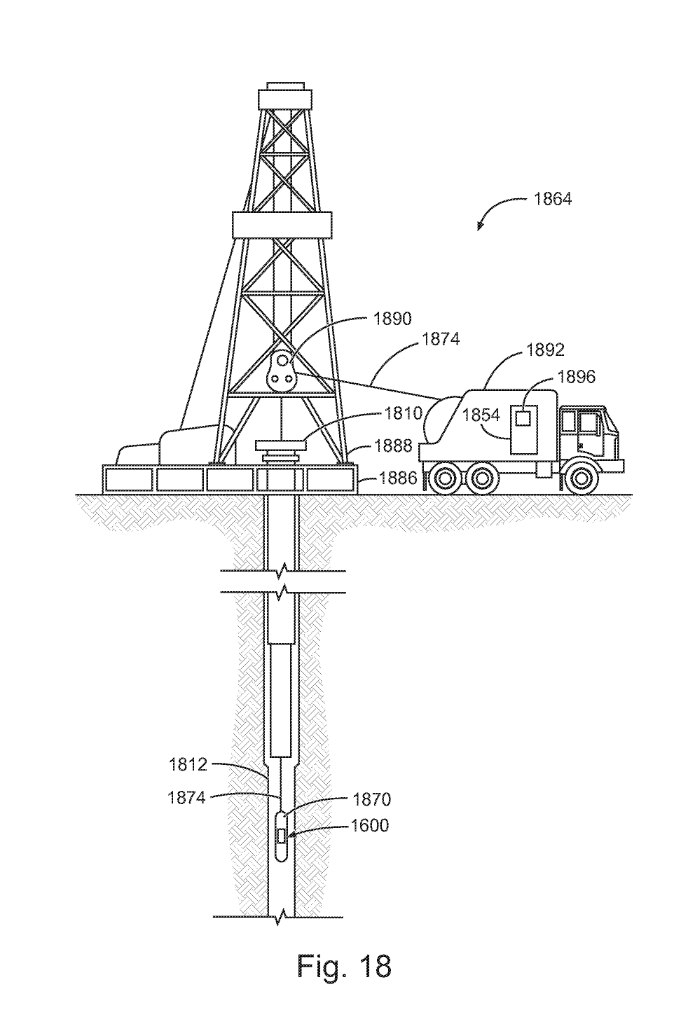

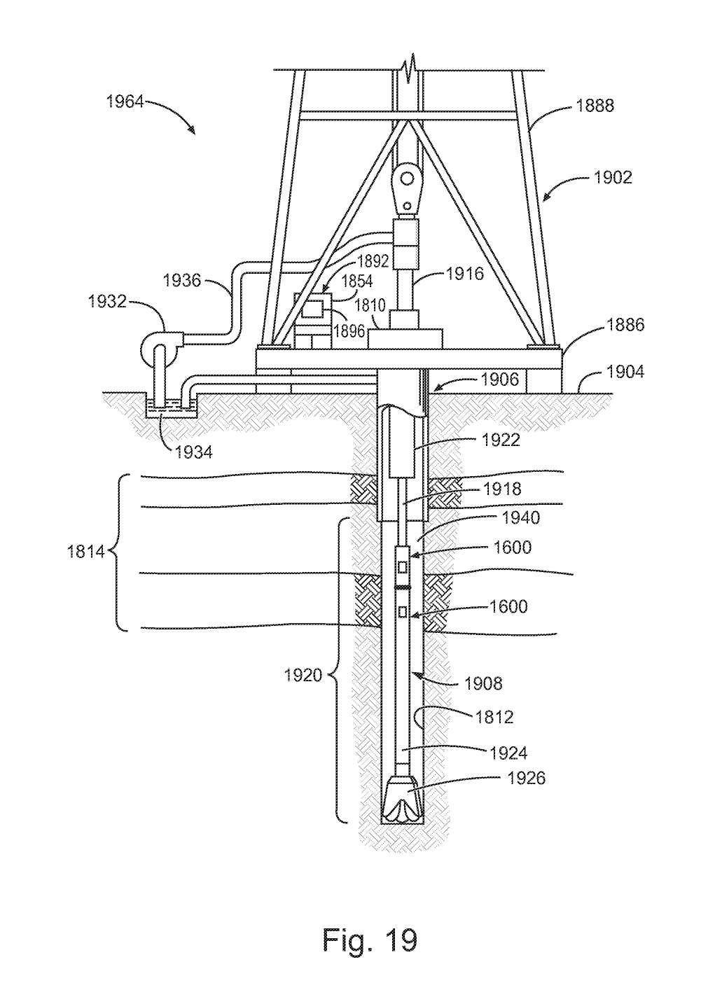

In some embodiments, a housing, such as a wireline tool body, or a downhole tool, can be used to house one or more components of the apparatus 1600 and system 1610, as described in more detail below with reference to FIGS. 18 and 19. The processing unit 1602 may be part of a surface workstation or attached to a downhole tool housing.

The apparatus 1600 and system 1610 can include other electronic apparatus 1665 (e.g., electrical and electromechanical valves and other types of actuators), and a communications unit 1640, perhaps comprising a telemetry receiver, transmitter, or transceiver. The controller 1625 and the processing unit 1602 can each be fabricated to operate the measurement device 1604 to acquire measurement data, including but not limited to measurements representing any of the physical parameters described herein. Thus, in some embodiments, such measurements are made within the physical world, and in others, such measurements are simulated. In many embodiments, physical parameter values are provided as a mixture of simulated values and measured values, taken from the real-world environment. The measurement device 1604 may be immersed directly within the flow, or attached to another element 1680 (e.g., a drill string, sonde, conduit, housing, or a container of some type) to sample flow characteristics as the flow passes by the device.

The bus 1627 that may form part of an apparatus 1600 or system 1610 can be used to provide common electrical signal paths between any of the components. The bus 1627 can include an address bus, a data bus, and a control bus, each independently configured. The bus 1627 can also use common conductive lines for providing one or more of address, data, or control, the use of which can be regulated by the processing unit, and/or the controller 1625.

The bus 1627 can include circuitry forming part of a communication network. The bus 1627 can be configured such that the components of the system 1610 are distributed. Such distribution can be arranged between downhole components and components that can be disposed on the surface of the Earth. Alternatively, several of these components can be co-located, such as in or on one or more collars of a drill string or as part of a wireline structure.

In various embodiments, the apparatus 1600 and system 1610 includes peripheral devices, such as one or more display units 1655, additional storage memory, or other devices that may operate in conjunction with the controller 1625 or the processing unit 1602, such as a monitor 1684, which may operate within the confines of the processing unit 1602, or externally, perhaps coupled directly to the bus 1627.

The display units 1655 can be used to display diagnostic information, measurement information, regime information, control system commands, as well as combinations of these, based on the signals generated and received, according to various method embodiments described herein. The monitor 1684 may be used to track the values of one or more measured flow parameters, simulated flow parameters, and regime proximity values to initiate an alarm or a signal that results in activating functions performed by the controller 1625 and/or the controlled device 1670.

In an embodiment, the controller 1625 can be fabricated to include one or more processors. The display units 1655 can be fabricated or programmed to operate with instructions stored in the processing unit 1602 (and/or in the memory 1606) to implement a user interface to manage the operation of the apparatus 1600 or components distributed within the system 1610. This type of user interface can be operated in conjunction with the communications unit and the bus 1627. Various components of the system 1610 can be integrated with the apparatus 1600 or associated housing such that processing identical to or similar to the methods discussed with respect to various embodiments herein can be performed downhole.

In various embodiments, a non-transitory machine-readable storage device can comprise instructions stored thereon, which, when performed by a machine, cause the machine to become a customized, particular machine that performs operations comprising one or more features similar to or identical to those described with respect to the methods and techniques described herein. A machine-readable storage device, herein, is a physical device that stores information (e.g., instructions, data), which when performed, alters the physical structure of the device. Examples of machine-readable storage devices can include, but are not limited to, memory 1606 in the form of read only memory (ROM), random access memory (RAM), a magnetic disk storage device, an optical storage device, a flash memory, and other electronic, magnetic, or optical memory devices, including combinations thereof.

The physical structure of stored instructions may be operated on by one or more processors such as, for example, the processing unit 1602. Operating on these physical structures can cause the machine to perform operations according to methods described herein. The instructions can include instructions to cause the processing unit 1602 to store associated data or other data in the memory 1606. The memory 1606 can store the results of measurements of fluid, formation, and other parameters. The memory 1606 can store a log of measurements that have been made. The memory 1606 therefore may include a database, for example a relational database. Thus, still further embodiments may be realized.

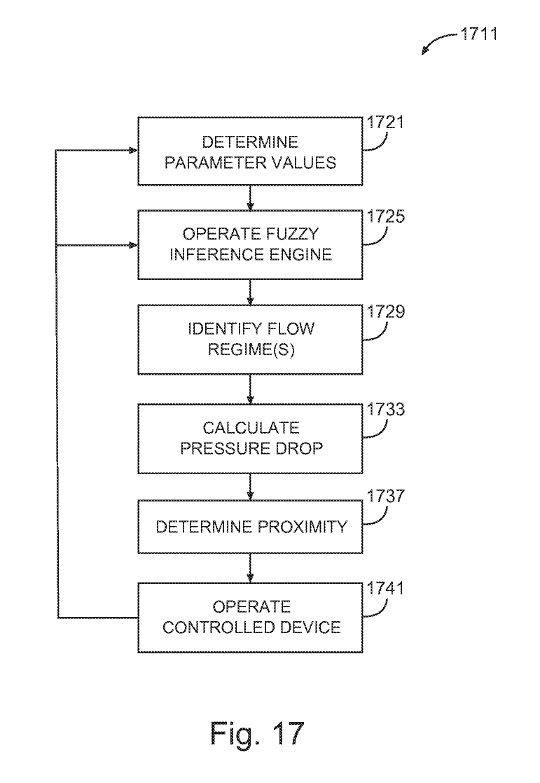

For example, FIG. 17 is a flow diagram illustrating methods 1711 of identifying regimes, and smoothing discontinuities between them, according to various embodiments. The methods 1711 described herein include and build upon the methods, apparatus, systems, and information illustrated in FIGS. 1-16. Some operations of the methods 1711 can be performed in whole or in part by the processing unit 1602, the apparatus 1600, and the system 1610, or any component thereof (see FIG. 16). Thus, referring now to FIGS. 1-17, it can be seen that in some embodiments, a method 1711 comprises identifying fluid flow regimes using attributes and fuzzy logic at block 1729, to provide an output that can be used to operate a controlled device at block 1741.

In some embodiments of the method 1711, activities begin at block 1721 with determining the parameter values that will be used to feed the input of the FIS. These can be obtained by measurement, experimental observation, or simulation, and combinations of these.

Fuzzy logic processing may include mapping the physical parameter values according to defined membership functions, thus, in some embodiments, the method 1711 may continue on to block 1725 to include fuzzy logic processing, wherein the fuzzy logic processing comprises operating a fuzzy inference engine according to logical statements comprising fuzzy operations on the physical parameter values to determine a mapping of the physical parameter values within defined membership functions.

Fuzzy logic processing may be expanded to include descriptive parameters. For example, fluctuations in heat transfer or vibrations may signify the presence of a slug regime which, when coupled with one or two other simulated or measured parameters, can present a range of change for a parameter, in order to avoid or maintain the slug flow. Thus, in some embodiments, the activity at block 1725 comprises receiving results of one of a heat transfer analysis or a vibration analysis, either real or simulated, to form a part of the inputs.

The method 1711 may continue on to block 1729 to include identifying one or more fluid flow regimes as an output of fuzzy logic processing, with inputs to the fuzzy logic processing comprising a set of physical parameter values as attributes at a location in a fluid flow that are determined by at least one of measurement or simulation

A variety of flow regimes may be identified, perhaps moving through a conduit, such as a pipe having a substantially circular cross-sectional area. Thus, in some embodiments, the one or more fluid flow regimes comprise at least one of a two-phase flow regime, a three-phase flow regime, or a four-phase flow regime. In turn, in some embodiments, the two-phase flow regime comprises a gas-liquid flow regime, including at least one of a quiescent mixture, a single-phase gas, a single-phase liquid, a dispersed bubble regime, a stratified smooth regime, a stratified wavy regime, an annular regime, a slug regime, a churn regime, an elongated bubble regime, or a bubbly regime.

In some embodiments, the two-phase flow regime comprises at least one of a liquid-liquid flow, a gas-solid flow, or a liquid-solid flow. In some embodiments, the fluid flow comprises the two-phase flow that occurs in an annulus, a channel, a conduit, or a duct having a non-circular pie-shaped cross-section.

In some embodiments, the three-phase flow regime comprises a gas-liquid-liquid flow regime, including at least one of a stratified smooth, stratified wavy, or emulsion of liquid in combination with a gas-liquid regime. Thus, in some embodiments, the three-phase flow comprises at least one of a liquid-liquid-liquid flow, a gas-liquid-solid flow, or a liquid-liquid-solid flow. In some embodiments, the fluid flow comprises a three-phase flow in a non-circular pipe, an annulus, or a channel.

Solids loading examples include two-phase gas-solid regimes such as homogeneous, dune, slug, and packed bed; or two-phase liquid-solid regimes such as homogeneous, heterogeneous, strand, and slug. Thus, in some embodiments, the four-phase flow regime comprises a gas-liquid-liquid-solid flow regime, including at least one of a regime from a gas-liquid-liquid flow with solids loading. In some embodiments, the fluid flow thus comprises a four-phase flow, including at least one of a liquid-liquid-liquid-solid flow, a gas-gas-liquid-solid flow, or a liquid-liquid-solid-solid flow. In some embodiments, the fluid flow comprises a four-phase flow that occurs in a conduit, an annulus, or a channel.

The fluid flow may comprises a contained fluid flow that occurs within a variety of containers. For example, in some embodiments, the fluid flow comprises a contained fluid flow that occurs within a pipe, a conduit, a fluidized bed container, or a well bore of a geological formation.

The location at which the flow regimes are identified may include an access port in a pipeline, such as an oil or gas pipeline, or a chemical plant processing pipeline. Thus, in some embodiments, the location comprises an access port in a pipeline.

A pressure drop indicating the proximity of neighboring regimes may also be used to operate the controlled device, in conjunction with the basic output, or apart from it, as a derivative of the basic output. Thus, in some embodiments, the method 1711 includes, at block 1733, calculating a pressure drop value accounting for proximity of neighboring regimes, based on the output, at the location

Proximity to transition zones between fluid flow regimes can be used to initiate alarm signals. Thus, in some embodiments, the method 1711 includes, at block 1737, determining proximity to fluid flow regime transition zones based on the identified fluid flow regimes.

The method 1711 may continue on to block 1741 to include operating a controlled device based on the output. Indeed, a variety of devices may be controlled, including electrical devices (e.g., a display, a solenoid, a switch, a transistor, or an input/output port) and mechanical devices (e.g., a valve, a linear actuator, a pump, a compressor, or a rotary actuator). Thus, the activity at block 1741 may include operating the controlled device comprising at least one of an electrical device or a mechanical device.

In some embodiments, the activity at block 1741 comprises operating the controlled device based on at least the pressure drop value accounting for proximity of neighboring regimes. In some embodiments, the activity at block 1741 comprises operating the controlled device to include initiating an alarm signal based on the proximity. Still further embodiments may be realized.

For example, in some embodiments, a method 1711 comprises, at block 1721, selecting a location in a fluid flow at which one or more physical properties can be measured. Using the measured values, simulation may be performed to determine other (non-measured) values for that location. In this way, parameter measurements can be combined with simulations to determine the values of additional parameters. Finally, the regime can be determined at block 1729, and the operation of an electrical or mechanical device can be affected at block 1741. This type of process can be quite useful for monitoring and improving the operations of physical systems, to control their operations in a predictable manner as regime boundaries change within the flow.

In some embodiments, after a measurement or monitoring location is selected, and one or more fluid property measurement devices are installed to make measurements, a method 1711 includes, at block 1721, measuring physical parameter values associated with the fluid flow at the selected location. For example, the location for measurement or monitoring might be a convenient access point along a pipeline, such as an oil or gas pipeline, or a chemical plant processing pipeline. Thus, the location may comprise an access port in a pipeline, among others.

Once one or more regimes have been identified at block 1729, these may be communicated to a variety of locations, including a processing unit, a controller, and/or a simulator, such as a piping simulator for further analysis and processing.

Fuzzy logic can be used to provide stable, accurate simulation and control systems. Different descriptive parameters, and the behavior of fluids associated with them, may be monitored, and controlled—in real time, or predicatively. Thus, the fuzzy logic may be applied at block 1725 to additional descriptive parameters, including at least one of heat transfer or vibration analysis. The method 1711 may thus include, at block 1721, simulation of the measured or monitored system, or a portion of the system, to provide values for fluid flow parameters that have not been measured, but may be inferred from the characteristics of the system, such as its physical properties, environmental conditions, and the values of parameters that have been measured.

Fluid flow may exist as a contained internal fluid flow in a variety of physical settings. Thus, measured and/or monitored fluid flow may be contained by, and occur within a pipe, conduit, a fluidized bed container, or within a well bore of a geological formation.

The fuzzy controller can provide device control based on the regime identified. The controlled device might include one or more electrical devices (e.g., a solenoid, a switch, a transistor, or an input/output port) or mechanical devices (e.g., a valve, a linear actuator, or a rotary actuator).

The regimes can be any one or more of several identified regimes. Thus, one or more regimes may be selected as a quiescent mixture, a single-phase gas, a single-phase liquid, a dispersed bubble regime, a stratified smooth regime, a stratified wavy regime, an annular regime, a slug regime, a churn regime, an elongated bubble regime, or a bubbly regime.

It should be noted that the methods described herein do not have to be executed in the order described, or in any particular order. Moreover, various activities described with respect to the methods identified herein can be executed in iterative, serial, or parallel fashion. Information, including parameters, commands, operands, and other data, can be sent and received in the form of one or more carrier waves. For example, the method may be executed iteratively for cases where limited measurement data is available, with a feedback loop. Loops may also be executed between other blocks, depending on the measurement and simulation capabilities.

Upon reading and comprehending the content of this disclosure, one of ordinary skill in the art will understand the manner in which a software program can be launched from a computer-readable medium in a computer-based system to execute the functions defined in the software program. One of ordinary skill in the art will further understand the various programming languages that may be employed to create one or more software programs designed to implement and perform the methods disclosed herein. For example, the programs may be structured in an object-orientated format using an object-oriented language such as Java or C#. In another example, the programs can be structured in a procedure-orientated format using a procedural language, such as assembly or C. The software components may communicate using any of a number of mechanisms well known to those of ordinary skill in the art, such as application program interfaces or interprocess communication techniques, including remote procedure calls. The teachings of various embodiments are not limited to any particular programming language or environment. Thus, other embodiments may be realized.

For example, as described earlier herein, simulators and control systems can be used in combination with a logging-while-drilling (LWD) or measurement-while drilling (MWD) assembly or a wireline logging tool. Either are operable in conjunction with an apparatus to conduct measurements in a wellbore, to determine the existence of flow regimes therein, and to change operations accordingly. Thus, the systems may comprise portions of a wireline logging tool body as part of a wireline logging operation, or of a downhole tool (e.g., a drilling operations tool) as part of a downhole drilling operation.

For example, as described earlier herein, simulators and control systems can be used in combination with a LWD/MWD assembly or a wireline logging tool. FIG. 18 depicts an example system 1864 in the form of a wireline system, according to various embodiments. FIG. 19 depicts an example system 1964, in the form of a drilling system, according to various embodiments.

Either of the systems 1864, 1964 in FIGS. 18 and 19 are operable in conjunction with the apparatus 1600 to conduct measurements in a wellbore, to use fuzzy logic to determine the existence and proximity to flow regimes therein, and to change operations accordingly. Thus, the systems 1610 may comprise portions of a wireline logging tool body 1870 as part of a wireline logging operation, or of a downhole tool 1924 (e.g., a drilling operations tool) as part of a downhole drilling operation.

Returning now to FIG. 18, a well during wireline logging operations can be seen. In this case, a drilling platform 1886 is equipped with a derrick 1888 that supports a hoist 1890.

Drilling oil and gas wells is commonly carried out using a string of drill pipes connected together so as to form a drilling string that is lowered through a rotary table 1810 into a wellbore or borehole 1812. Here it is assumed that the drilling string has been temporarily removed from the borehole 1812 to allow a wireline logging tool body 1870, such as a probe or sonde, to be lowered by wireline or logging cable 1874 into the borehole 1812. Typically, the wireline logging tool body 1870 is lowered to the bottom of the region of interest and subsequently pulled upward at an approximately constant speed.

During the upward trip, at a series of depths, the instruments (e.g., the apparatus 1600 shown in FIG. 16) included in the tool body 1870 may be used to perform measurements on the subsurface geological formations adjacent the borehole 1812 (and the tool body 1870). The measurement data can be communicated to a surface logging facility 1892 for storage, processing, and analysis. The logging facility 1892 may be provided with electronic equipment for various types of signal processing, including any of the apparatus described herein. Similar formation evaluation data may be gathered and analyzed during drilling operations (e.g., during LWD operations, and by extension, sampling while drilling and MWD), and displayed on a display 1896.

In some embodiments, the tool body 1870 comprises an apparatus 1600 for obtaining and analyzing measurements in a subterranean formation through a borehole 1812. The tool is suspended in the wellbore by a wireline cable 1874 that connects the tool to a surface control unit (e.g., comprising a workstation 1854, which can also include a display 1896). The tool may be deployed in the borehole 1812 on coiled tubing, jointed drill pipe, hard wired drill pipe, or any other suitable deployment technique.

Turning now to FIG. 19, it can be seen how a system 1964 may also form a portion of a drilling rig 1902 located at the surface 1904 of a well 1906. The drilling rig 1902 may provide support for a drill string 1908. The drill string 1908 may operate to penetrate the rotary table 1810 for drilling the borehole 1812 through the subsurface formations 1814. The drill string 1908 may include a Kelly 1916, drill pipe 1918, and a bottom hole assembly 1920, perhaps located at the lower portion of the drill pipe 1918.

The bottom hole assembly 1920 may include drill collars 1922, a downhole tool 1924, and a drill bit 1926. The drill bit 1926 may operate to create the borehole 1812 by penetrating the surface 1904 and the subsurface formations 1814. The downhole tool 1924 may comprise any of a number of different types of tools including MWD tools, LWD tools, and others.

During drilling operations, the drill string 1908 (perhaps including the Kelly 1916, the drill pipe 1918, and the bottom hole assembly 1920) may be rotated by the rotary table 1810. Although not shown, in addition to, or alternatively, the bottom hole assembly 1920 may also be rotated by a motor (e.g., a mud motor) that is located downhole. The drill collars 1922 may be used to add weight to the drill bit 1926. The drill collars 1922 may also operate to stiffen the bottom hole assembly 1920, allowing the bottom hole assembly 1920 to transfer the added weight to the drill bit 1926, and in turn, to assist the drill bit 1926 in penetrating the surface 1904 and subsurface formations 1814.

During drilling operations, a mud pump 1932 may pump drilling fluid (sometimes known by those of ordinary skill in the art as “drilling mud”) from a mud pit 1934 through a hose 1936 into the drill pipe 1918 and down to the drill bit 1926. The drilling fluid can flow out from the drill bit 1926 and be returned to the surface 1904 through an annular area 1940 between the drill pipe 1918 and the sides of the borehole 1812. The drilling fluid may then be returned to the mud pit 1934, where such fluid is filtered. In some embodiments, the drilling fluid can be used to cool the drill bit 1926, as well as to provide lubrication for the drill bit 1926 during drilling operations. Additionally, the drilling fluid may be used to remove subsurface formation cuttings created by operating the drill bit 1926.

Thus, it may be seen that in some embodiments, the systems 1864, 1964 may include a drill collar 1922, a downhole tool 1924, and/or a wireline logging tool body 1870 to house one or more apparatus 1600, similar to or identical to the apparatus 1600 described above and illustrated in FIG. 16.

Thus, for the purposes of this document, the term “housing” may include any one or more of a drill collar 1922, a downhole tool 1924, or a wireline logging tool body 1870 (all having an outer wall, to enclose or attach to magnetometers, sensors, fluid sampling devices, pressure measurement devices, transmitters, receivers, acquisition and processing logic, and data acquisition systems). The tool 1924 may comprise a downhole tool, such as an LWD tool or MWD tool. The wireline tool body 1870 may comprise a wireline logging tool, including a probe or sonde, for example, coupled to a logging cable 1874. For example, a system 1610 may comprise a downhole tool body (in the form of element 1680), such as a wireline logging tool body 1870 or a downhole tool 1924 (e.g., an LWD or MWD tool body), and one or more apparatus 1600 attached to the tool body, the apparatus 1600 to be constructed and operated as described previously. Still further embodiments may be realized.

For example, referring now to FIGS. 16-19, it can be seen that a system 1610, 1864, 1964 may comprise one or more fluid parameter measurement devices 1604, a processing unit 1602 to determine fluid flow regime transition zone proximity, and an actuator (e.g., the controller 1625) to effect control over a device 1670. In this way, one or more flow properties can be measured, others can be simulated, and then control commands 1668 can be formulated to affect the operation of a controlled device 1670.

In some embodiments, a system 1610 comprises a processing unit 1602 to receive input from a measurement device 1604, and a controlled device 1670 to operate based on the resulting output of the processing unit 1602. This output may take the form of messages 1668, or control signals 1672, and generally comprises a response to the identification of flow regimes, and calculated/smoothed pressure drops determined according to any of the methods described herein.

In some embodiments, a control system 1610 comprises at least one fluid parameter measurement device to provide a measured value of at least one attribute of a fluid or of the flow, at a location within a flow of the fluid; a processing unit to identify one or more fluid flow regimes as an output of fuzzy logic processing, with the measured value of the at least one attribute as an input to the fuzzy logic processing; and a controlled device to operate in response to at least one of the output, or to a pressure drop value accounting for proximity of nearby-neighboring regimes based on the output.

Fluid parameter measurement devices may be attached to a variety of elements in the system. Thus, in some embodiments, the system 1610 comprises at least one of an element 1680, such a pipe, an annulus, a conduit, a downhole logging tool, or a fluidized bed container, attached to the fluid parameter measurement device.

A pump can operate as the controlled device, to control the fluid flow. Thus, in some embodiments, the system 1610 comprises at least one valve or a pump electrically coupled to the processing unit, the valve or the pump comprising at least part of the controlled device 1670 to control the flow of the fluid.

A slug catcher can be operated as the controlled device. Thus in some embodiments, the controlled device 1670 comprises a slug catcher to be activated when the one or more fluid flow regimes is identified as a slug flow regime.

The fluid parameter measurement device(s) can be attached to a number of components in the system. Thus, in some embodiments of the system 1610, at least one fluid parameter measurement device 1604 comprises one or more of a density measurement device, a pressure measurement device, a flow rate measurement device, or a temperature measurement device.

The system 1610 may include an element 1680, such as a wireline probe. Thus, in some embodiments, the system 1610 comprises a wireline probe attached to the fluid parameter measurement device 1604, wherein the controlled device 1670 is to be operated to avoid identified ones of dispersed bubble or bubbly flows as part of the one or more fluid flow regimes, in favor of single-phase liquid flow, to reduce the release of gas from liquid oil in the well.

The system 1610 may include an element 1680, such as a drill string. Thus, in some embodiments, the system 1610 comprises a drill string 1908 attached to the fluid parameter measurement device 1604, wherein the controlled device 1670 is to be operated to avoid identified ones of bubble, slug, or churn flows as part of the one or more fluid flow regimes, in favor of annular or single-phase gas flows, to reduce water cut in a gas well during drilling operations.

Many devices can be controlled according to the output of the fuzzy logic (e.g., as an identified fluid flow regime), or pressure drop accounting for proximity of nearby-neighboring regimes, including pumps, sucker rods, separators, and inflow control devices, either to avoid undesirable flow regimes, or to maintain desirable flow regimes. Thus, in some embodiments, the system 1610 comprises a controlled device 1670 that is controlled to maintain identification of a selected one of the fluid flow regimes within the flow of the fluid.

In some embodiments of the system 1610, the controlled device 1670 comprises a pump that is to be operated to avoid identified ones of bubbly or slug flows as part of the one or more fluid flow regimes, in favor of dispersed bubble or single-phase liquid flows, to reduce probability of gas locking in an oil well. In some embodiments of the system 1610, the controlled device 1670 comprises a sucker rod that is to be operated to avoid identified ones of bubbly, slug, elongated bubble, or churn flows as part of the one or more fluid flow regimes, in favor of dispersed bubble or single-phase liquid flows in an oil well. In some embodiments of the system 1610, the controlled device 1670 comprises a separator that is to be operated to avoid identified ones of intermittent slug, elongated bubble, or churn flows as part of the one or more fluid flow regimes, in favor of stratified smooth or stratified wavy flows, to reduce dwell time in the separator. In some embodiments of the system 1610, the controlled device 1670 comprises a downhole inflow control device that is to be operated to avoid identified annular flow as part of the one or more fluid flow regimes, in favor of single-phase gas flow in a gas well to reduce water production.

Some embodiments include a fluid transport system that includes a conduit and a controlled device that operates to control flow within the system. Thus, in some embodiments, a fluid transport system 1610 comprises a fluid conduit as an element 1680 coupled to at least one fluid parameter measurement device 1604 to measure at least one property of fluid flow at a location in the fluid conduit. The system 1610 further includes a controlled device 1670 comprising a pump or a valve to control the fluid flow, as directed by a processing unit 1602 having access to an identification of one or more fluid flow regimes provided as an output of fuzzy logic processing, with inputs to the fuzzy logic processing comprising a set of physical parameter values as attributes at a location in a fluid flow that are determined by at least one of measurement or simulation.

System conditions can be monitored, based on regime identification, or transition to an intermittent regime (e.g., slug, elongated bubble or churn), to initiate remedial or corrective activity. Thus in some embodiments, a system 1610 comprises a monitor 1684 to provide an erosion signal for the fluid conduit (e.g., as the element 1680) due to particulate transport when the identification indicates transition to an intermittent regime has not been avoided in favor of a stratified wavy regime or a stratified smooth regime.

In some embodiments, a system 1610 comprises a monitor 1684 to provide a particulate deposition signal (e.g., as one of the signals 1672) for the fluid conduit (e.g., as the element 1680) when the identification indicates that a stratified wavy regime or a stratified smooth regime has not been avoided in favor of an intermittent regime.

In some embodiments, a system 1610 comprises a monitor 1684 to provide a signal (e.g., as one of the signals 1672) to indicate onset of emulsion flow in a liquid-liquid flow, to be avoided by reducing the flow rate to allow easier separation of produced liquid components.

In some embodiments, a system 1610 comprises a monitor 1684 to provide a signal (e.g., as one of the signals 1672) to indicate onset of slug flow in a gas-liquid-liquid-solid flow, to be avoided in favor of stratified flow, to reduce water production and erosion by solid particles in a pipeline.

An intermittent multiphase flow regime may include slug flow, with the flow including at least one phase being gas, and one phase being liquid. Annular flow may be used to reduce the heat transfer from the production fluids in a wellbore, to avoid wax or hydrate formation. Thus, in some embodiments, a system 1610 comprises a monitor 1684 to provide a signal (e.g., as one of the signals 1672) to indicate an intermittent multiphase flow regime, to be avoided in favor of annular flow to reduce heat transfer from production fluids in a wellbore.

In some embodiments, a system 1610 comprises a monitor 1684 to provide a signal (e.g., as one of the signals 1672) indicating an undesired transition from a first one of the fluid flow regimes to a second one of the fluid flow regimes.

In some embodiments, a system 1610 comprises a monitor 1684 to provide a signal (e.g., as one of the signals 1672) indicating proximity to an intermittent regime as one of the fluid flow regimes as a prelude to a system failure mode.

The controlled device (e.g., pump and/or valve) may be operated in response to the signal that indicates the approach of a system failure mode. Thus, in some embodiments of the system 1610, the controlled device 1670 is operated to avoid the intermittent regime in response to a signal (e.g., as one of the signals 1672) indicating proximity to the intermittent regime.

Any of the above components, for example the apparatus 1600 (and each of its elements), and the systems 1610, 1864, 1964 (and each of their elements) may all be characterized as “modules” herein. Such modules may include hardware circuitry, and/or a processor and/or memory circuits, software program modules and objects, and/or firmware, and combinations thereof, as desired by the architect of the apparatus and systems, and as appropriate for particular implementations of various embodiments. For example, in some embodiments, such modules may be included in an apparatus and/or system operation simulation package, such as a software electrical signal simulation package, a power usage and distribution simulation package, a power/heat dissipation simulation package, a measured radiation simulation package, a fluid flow simulation package, and/or a combination of software and hardware used to simulate the operation of various potential embodiments.

It should also be understood that the apparatus and systems of various embodiments can be used in applications other than for logging operations, and thus, various embodiments are not to be so limited. Applications that may include the novel apparatus and systems of various embodiments include electronic circuitry used in high-speed computers, communication and signal processing circuitry, modems, processor modules, embedded processors, data switches, and application-specific modules. Thus, many embodiments may be realized.

For example a system 1610 may comprise one or more fluid parameter measurement devices 1604, a processing unit 1602 to determine fluid flow regime transition zone proximity, and an actuator (e.g., the controller 1625) to effect control over a device 1670. In this way, one or more flow properties can be measured, others can be simulated, and then control commands 1668 can be formulated to regulate the operation of a controlled device 1670.

The fluid parameter measurement device 1604 may be attached to piping, within a chemical processing plant, or downhole, etc.; to a downhole logging tool; or to a fluidized bed container. Thus, in some embodiments, a system 1610 may include an element 1680 attached to the fluid parameter measurement device 1604, the element 1680 comprise a pipe, a downhole logging tool, or a fluidized bed container. In some embodiments, the system 1610 may comprise additional elements 1680 attached to the fluid parameter measurement device 1604, such as a container to contain a portion of the fluid in a pipe, conduit, or wellbore.

The system 1610 may incorporate a programmable logic controller that operates valves and other devices, to control the fluid flow. Thus, in some embodiments, the system 1610 may comprise at least one valve (e.g., as a controlled device 1670) electrically coupled to a programmable logic controller (e.g., as a controller 1625), to control the flow of the fluid.

A number of controlled devices 1670 may operate within the system 1610, according to the regime identified. One such device 1670 includes a slug catcher that may be put into operation when the proximity to a slug flow regime exceeds a threshold value. Thus, in some embodiments of the system, the controlled device 1670 comprises a slug catcher to be activated when the slug flow regime is identified.

A pump on the surface may be controlled by the processing unit, according to the regime identified. Power to the pump and thus the flow rate can be controlled by the processing unit or the controller according to identification of the dispersed bubble or bubbly regimes, as opposed to the identification of the intermittent regimes (slug, elongated bubble, and churn), perhaps avoiding the latter to maintain uninterrupted flow and provide sufficient cooling to the pump in an oil well. Thus, in some embodiments of the system 1610, the controlled device 1670 comprises an external pump to transport the fluid.

The fluid parameter measurement device may include a number of different device types. Thus, in some embodiments of the system 1610, the fluid parameter measurement device 1604 comprises one or more of a density measurement device, a pressure measurement device, a flow rate measurement device, or a temperature measurement device.

The fluid parameter measurement device can be attached to a wireline logging tool. To improve the technology used to recover fluid from an oil well, fuzzy logic can be used to facilitate optimal operation. Thus, some embodiments of the system 1610 comprise a wireline probe (e.g., a wireline logging tool) attached as an element 1680 to the fluid parameter measurement device 1604, wherein the controlled device 1670 is to be operated to avoid dispersed bubble or bubbly flows based on their identification, in favor of single-phase liquid flow, to reduce the release of gas from liquid oil in the well.

The fluid parameter measurement device can be attached to a drill string. The fuzzy logic can then be used to encourage optimal well operating conditions. Thus, some embodiments of the system 1610 comprise a drill string 1908 as an element 1680 attached to the fluid parameter measurement device 1604, wherein the controlled device 1670 is to be operated to avoid bubble, slug, or churn flow in favor of annular or single-phase gas to minimize water cut in a gas well.

In some embodiments of the system, the controlled device 1670 comprises an electric pump that is to be operated to avoid bubbly or slug flow in favor of dispersed bubble or single-phase liquid to reduce probability of gas locking in an oil well.

In some embodiments of the system, the controlled device 1670 comprises a sucker rod that is to be operated to avoid bubbly, slug, elongated bubble, or churn flow, in favor of dispersed bubble or single-phase liquid in an oil well.

In some embodiments of the system, the controlled device 1670 comprises a separator that is to be operated to avoid intermittent slug, elongated bubble, or churn regimes in favor of stratified smooth or stratified wavy flow regimes to reduce dwell time in the separator.

Some regimes of operation can be avoided in favor of other regimes, to provide favorable operating conditions, such as improving the operational efficiency of technology. Thus, in some embodiments of the system 1610, selected regimes are maintained for more efficient operation. For example, some embodiments of the system 1610 are configured to maintain single-phase flow, or any other desired regime that is useful in a particular application, such as churn flow (e.g., where a mixing process is desired).

Many embodiments may thus be realized. For example, in some embodiments of the system 1610, the controlled device 1670 comprises a choke to be operated to maintain a selected one of the fluid flow regimes. In some embodiments of the system, the controlled device 1670 comprises a downhole inflow control device that is to be operated to avoid annular flow in favor of single-phase gas in a gas well.

Flow assurance issues within a piping system can also be addressed with the application of the methods, apparatus, and systems described herein. Control conditions can be selected and/or alarms can be set based on the identification of problematic flow conditions related to specific flow assurance situations. Thus, in some embodiments, a fluid transport piping system 1610 comprises an element 1680, such as a fluid conduit, coupled to at least one fluid parameter measurement device 1604 to measure at least one property of fluid flow at a location in the fluid conduit. The system 1610 may further include a controlled device 1670 comprising a pump or a valve to control the fluid flow, as directed by a processing unit 1602 having access to a numerical model of the fluid flow and at least one property of the fluid flow, based the identified flow regime at the location.

In some embodiments that operate to address flow assurance issues, particulate erosion can occur when less damaging flow regimes are not maintained. Thus, a system 1610 may comprise a monitor 1684 to indicate erosion of the fluid conduit due to particulate transport when transition to an intermittent regime is not avoided in favor of a stratified wavy regime or a stratified smooth regime.

In some embodiments that operate to address flow assurance issues, particulate deposition may be avoided by maintaining selected regimes. Thus, a system 1610 may comprise a monitor 1684 to indicate particulate deposition in the fluid conduit when a stratified wavy regime or a stratified smooth regime is not avoided in favor of an intermittent regime.

In some embodiments that operate to address flow assurance issues, hydrate formation and/or wax buildup can occur when an unexpected regime is entered. Thus, a system 1610 may comprise a monitor 1684 to indicate an unexpected transition from a first one of the regimes to a second one of the regimes.

In some embodiments that operate to address flow assurance issues, monitoring and alarming on identification of slug, elongated bubble, or churn regimes is employed. This may avoid excessive vibration, perhaps associated with fatigue failure. In this way, system life may be extended by changing operating conditions to maintain single-phase flow, or another two-phase flow regime (e.g., annular, stratified smooth, stratified wavy, dispersed bubble or bubbly). Thus, a system 1610 may comprise a monitor 1684 to identify an intermittent one of the regimes as a prelude to a system failure mode.

Many advantages can be gained by implementing the methods, apparatus, and systems described herein. For example, fuzzy logic is computationally efficient. Once implemented in software or hardware, it reduces or eliminates the chance of diverging numerical schemes associated with closure relations in existing mechanistic models.

In oil and gas production, a fuzzy logic controller can be used to optimize control of intelligent wells and fields. It provides fast, smooth, and robust control of pumps, compressors, valves, and chokes to improve the production of hydrocarbons and reduce the chance of transitioning to unfavorable regimes.

### Example 4: Fuzzy Logic to Identify Two-Phase, Gas-Liquid Regimes in Pipe Flow with Three Input Parameters and Seven Output Regimes

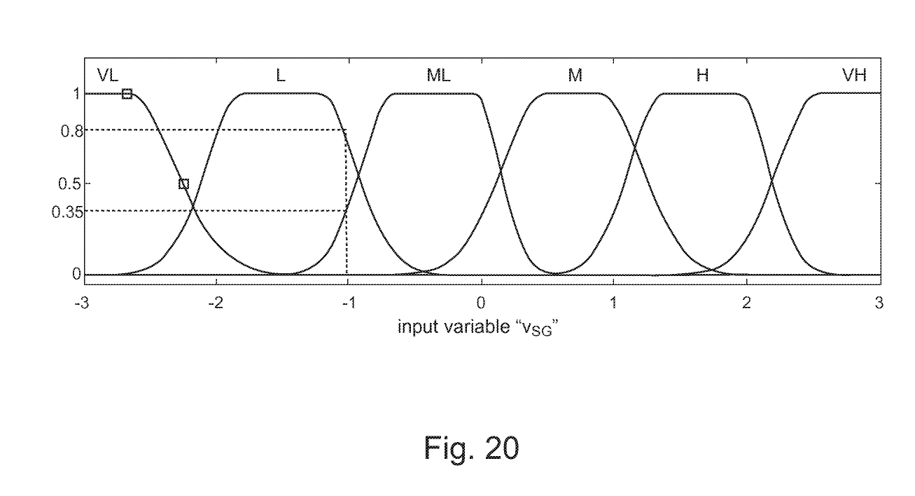

In this example two-phase, gas-liquid regimes in pipe flow with three input parameters are identified using the fuzzy logic approach and the outcome is compared with the mechanistic counterpart. Seven possible output regimes are considered in this case. The following definitions apply to the problem investigated:
Input linguistic variables: superficial gas velocity (v_{SG}), superficial liquid velocity (v_{SL}), pipe inclination angle (θ).
Output linguistic variables: dispersed bubble (DB), stratified smooth (SS), stratified wavy (SW), annular (AN), slug (SL), chum (CH), bubbly (BY).
Corresponding fuzzy set: collection of linguistic variables, represented by membership functions with partitions for the subsets; FIG. 20 through FIG. 23 provide additional details.

Membership Functions for the Input Variables.

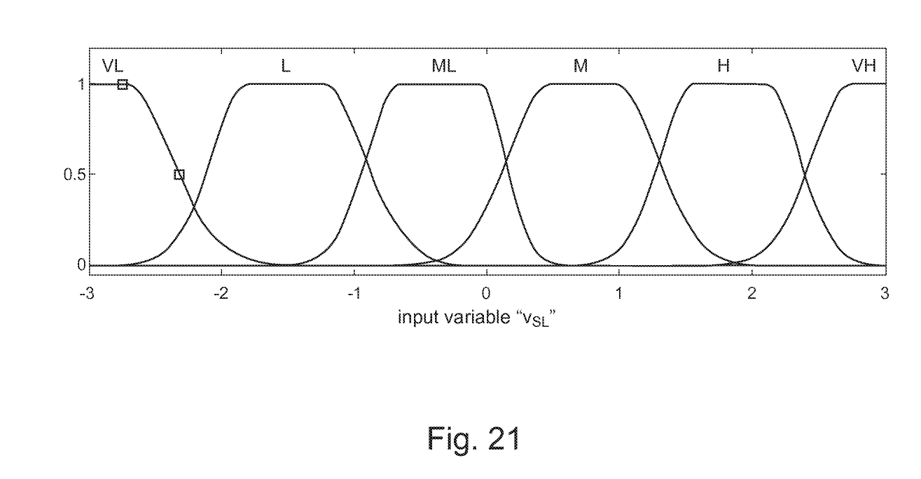

FIG. 20 illustrates a membership function 2000 for input variable v_{SG}, with an example of crisp to fuzzified input conversion, according to various embodiments. FIG. 21 illustrates a membership function 2100 for input variable v_{SL}, according to various embodiments. The selection of membership functions for the different input variables is based on expert knowledge of the system behavior. The membership functions are built to capture the sensitivity of flow regime prediction to the superficial velocities and pipe inclination angle. Experimental findings and mechanistic models indicate that, among the input parameters that define gas-liquid flows, the superficial velocities and pipe inclination are the most influential.

The range of superficial velocity of each phase spans six orders of magnitude and is represented on a logarithmic scale. Although the upper limit is much higher than would be allowed for subsonic flow, this range provides for the most convenient training from the mechanistic maps. Each decade approximately represents a subset that can have one of the following linguistic values:

Very Low (VL)

Low (L)

Medium Low (ML)

Medium (M)

High (H)

Very High (VH)

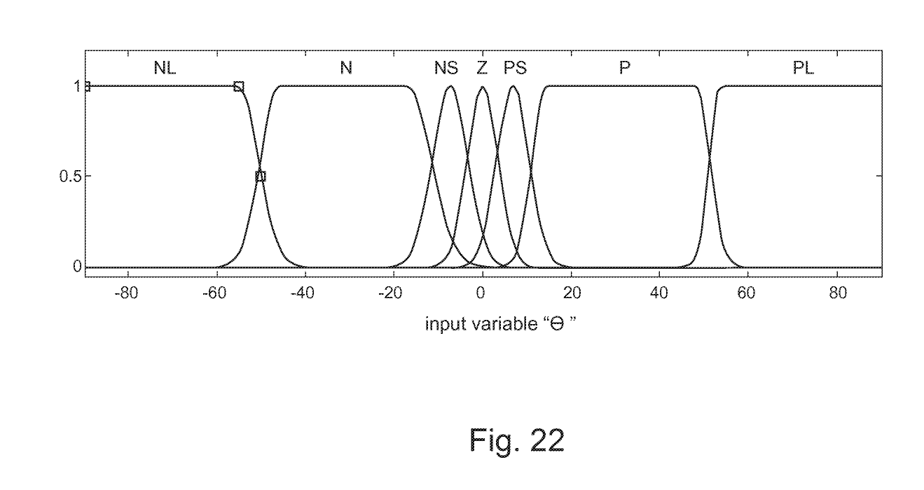

FIG. 22 illustrates a membership function 2200 for input variable θ, according to various embodiments. The pipe inclination range extends from vertical downward (θ=−90°) to vertical upward (θ=+90°). The partitioning of the range is refined to capture small positive and negative inclinations near horizontal, where the flow regime is most sensitive to inclination angle. The following linguistic values are assigned to the partitions:

Negative Large (NL)

Negative (N)

Negative Small (NS)

Zero (Z)

Positive Small (PS)

Positive (P)

Positive Large (PL)

Membership Functions for the Output Flow Regimes.

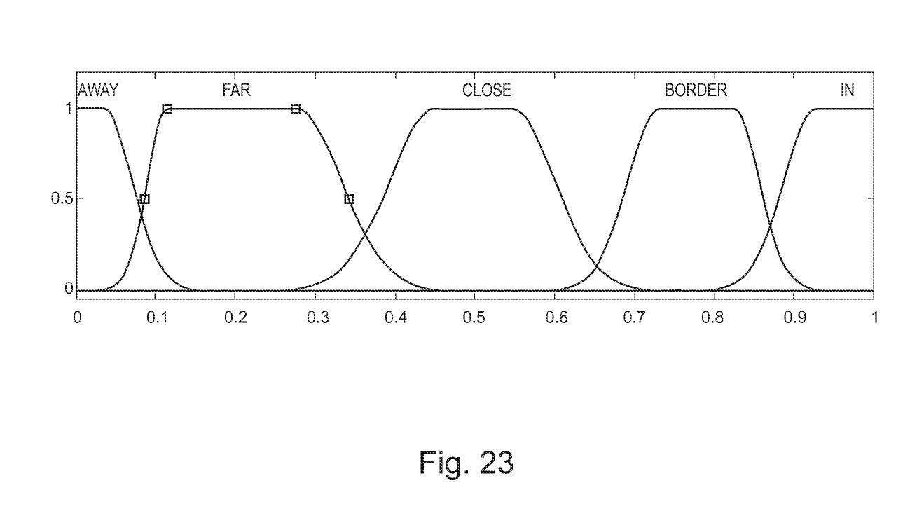

FIG. 23 illustrates a typical membership function 2300 for output flow regimes, according to various embodiments. For given values of input variables, the output is a flow pattern. A data point for the prescribed input variables can be exactly in a flow regime or on the boundary between two or more regimes. The position of the data point relative to the possible flow regimes is quantified in terms of the following linguistic values with respect to a regime map plotted in two input variables:
IN—positioned in the regime
BORDER—an adjacent regime that is ALSO WITHIN a 10% increase or decrease from the discretization of EITHER input parameter range
CLOSE—a neighboring regime, not necessarily adjacent, that is FARTHER than a 10% increase or decrease from the discretization of BOTH input parameter ranges AND CLOSER THAN one full discretization in BOTH input parameter ranges
FAR—separated by ONE intermediate regime and MORE THAN ONE full discretization in JUST ONE input parameter
AWAY—separated by AT LEAST one intermediate regime AND MORE than one full discretization in BOTH input parameters

Fuzzy Logic.

The mapping from the prescribed input variables to the output flow regimes is performed using fuzzy logic. This process is known as fuzzy inference or fuzzy reasoning and involves rules that are expressed in an antecedent-consequent (IF-THEN) form. Although there are several fuzzy inference methods, that of a Mamdani fuzzy interference system (FIS) is the most common and is used in this application. Mamdani FIS produces outputs using the procedure:
1. Establish a set of fuzzy rules.
   The rules are defined from experimental observations and/or mechanistic predictions recorded on maps. These maps show the flow regimes occurring for two of the input parameters varying over their respective ranges while the other input parameters are held constant.
2. Fuzzify the input variables using membership functions.
   In this step, the crisp numeric inputs are converted into fuzzy inputs, and values of membership to fuzzy subsets are obtained. For example, as shown in FIG. 20, the crisp value of 0.1 m/s assigned to v_{SG} has a membership of 0.35 in ML subset and 0.8 in L.
3. Combine the fuzzified inputs according to the fuzzy rules to determine the firing strength of each rule.
4. Determine the consequence of the rule by clipping the output membership functions at the rule strength.
5. Combine the consequences to obtain the output (also known as aggregation).
   After the output memberships are defined, they are further combined using the maximum (fuzzy OR) of the membership values
6. Defuzzify the output to obtain a crisp output value.
   Several methods can be used to perform defuzzification, all producing similar results. The centroid method was used for this application.

The number of rules defined as part of the inference system is 234 and results are produced based on this number. Other embodiments may use other numbers of rules.

The method is demonstrated on the flow of air and water at 20° C. and 1 atmosphere in a smooth pipe. In general, ten independent parameters influence the regime maps of two-phase, gas-liquid pipe flow. These parameters include the gas and liquid viscosities and densities, surface tension of the liquid in contact with the gas, pipe diameter, inclination angle and roughness, and superficial velocities of the gas and liquid.

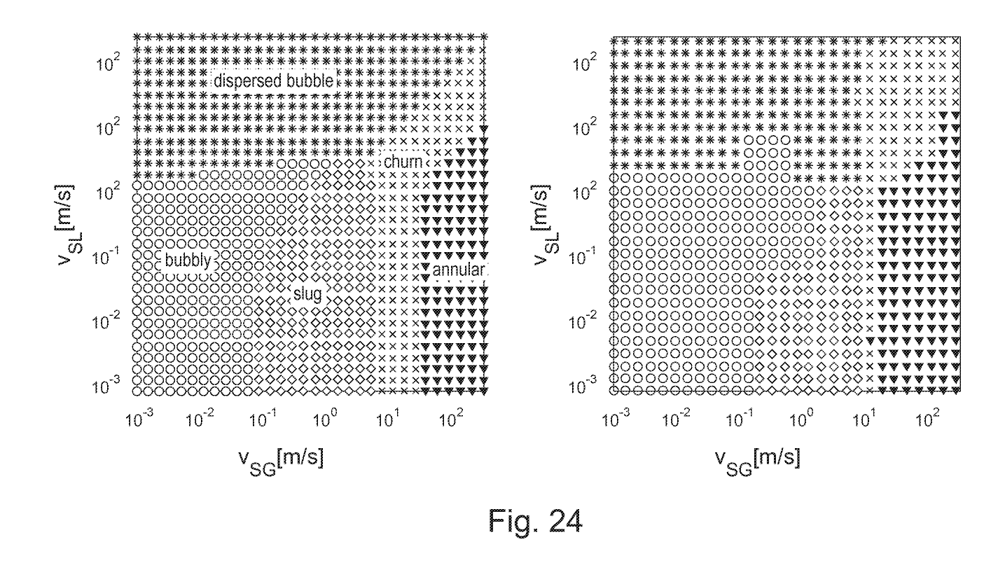

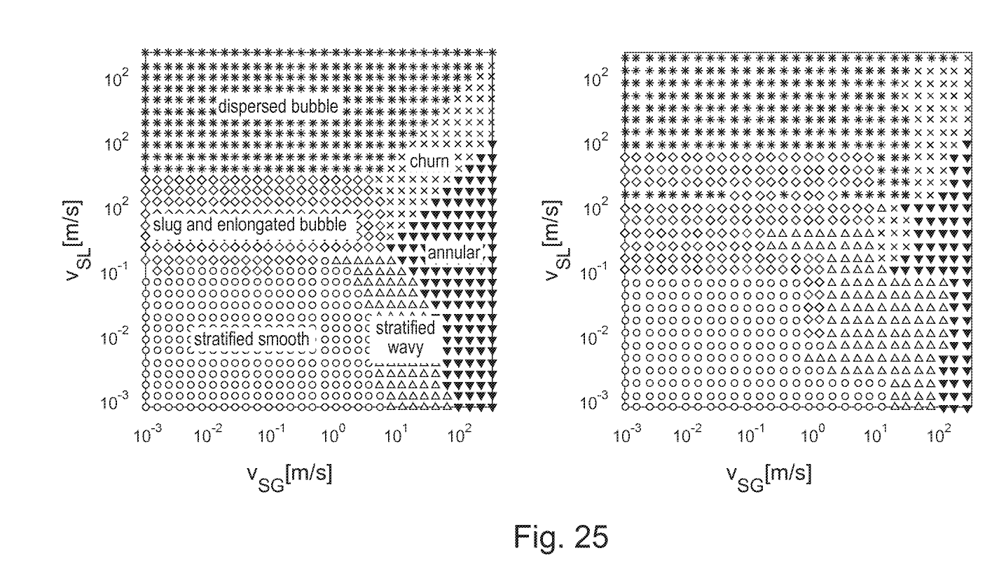

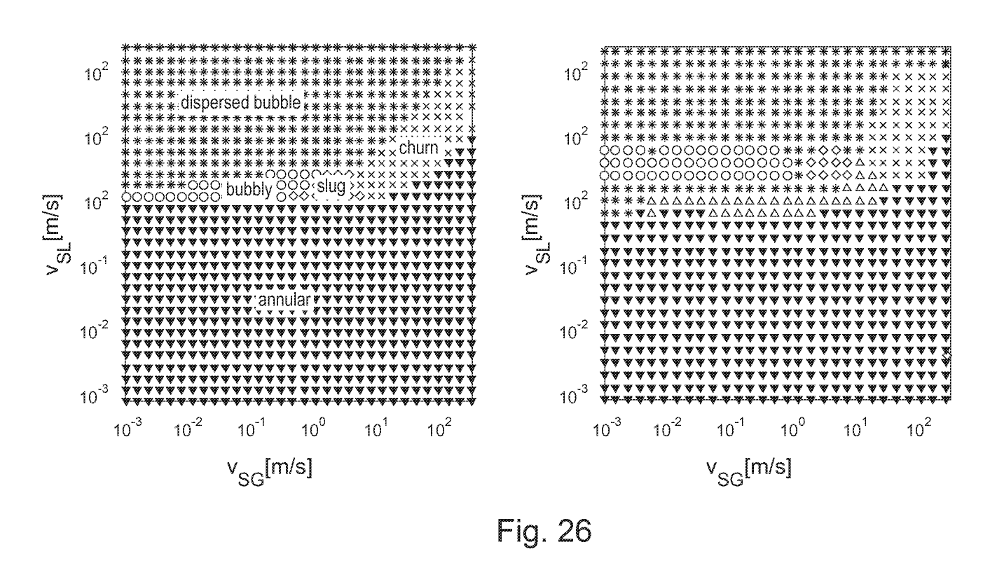

In this example, the dynamic (absolute) viscosities of air and water are assumed to be 1.825×10⁻⁵ kg/m-s and 1.002×10⁻³ kg/m-s, respectively. The densities of air and water are assumed to be 1.204 kg/m³ and 998.0 kg/m³, respectively. The surface tension of water in contact with air is assumed to be 0.073 N/m. The pipe is assumed to be smooth with diameter 0.1 m. The membership functions and rules are generated by considering the regimes predicted by six mechanistic maps. The first three mechanistic maps used to build the fuzzy system rules are in the space of gas and liquid superficial velocities. The ranges of superficial velocities are between 10⁻³ m/s and 1000 m/s, discretized by order of magnitude size steps, at pipe inclinations of horizontal (0°), vertical upward (+90°), and vertical downward (−90°). These three mechanistic maps are shown in the left side of FIGS. 24-26. FIG. 24 illustrates a mechanistic and fuzzy regime map prediction for θ=90° of air and water at 20° C. and 1 atm in 0.1 m diameter smooth pipe, according to various embodiments. FIG. 25 illustrates a mechanistic and fuzzy regime map prediction for θθ=0° (horizontal flow) of air and water at 20° C. and 1 atm in 0.1 meter (m) diameter smooth pipe, according to various embodiments. FIG. 26 illustrates a mechanistic and fuzzy regime map prediction for θ=−90° (vertical downward flow) of air and water at 20° C. and 1 atm in 0.1 m diameter smooth pipe, according to various embodiments.

In addition, three maps in the space of inclination angle versus superficial gas velocity are also used to generate rules and build membership functions. The discretization in inclination angle was finer near the horizontal position, as indicated by the membership functions shown in FIG. 22.

Several flow regime maps are generated using the resulting fuzzy inference system, based on the devised rules. These are compared with mechanistic counterparts. Overall, the agreement is very good, although it could be improved by increasing the number of subsets of different linguistic values within the membership functions assigned to both input and output variables. In addition, an increase in the number of rules to include more pipe inclination angles is expected to improve the prediction.

Comparison of Fuzzy Predictions with Mechanistic Expectations for Maps Used to Build Membership Functions and Rules.

The three mechanistic maps in v_{SG}-v_{SL} space that are used to build the fuzzy inference system are shown on the left sides of FIG. 24 through FIG. 26 for vertical upward (θ=+90°), horizontal (θ=0°) and vertical downward (θ=−90°) flow, respectively. These are based on the regime transition functions. These two-phase, gas-liquid pipe flow maps identify up to eight flow regimes, including dispersed bubble, bubbly, slug, elongated bubble, churn, annular, stratified smooth, and stratified wavy.

Elongated bubble flow is a special case of slug flow with liquid slugs that are free of gas bubbles. Elongated bubble flow occurs only over small parameter ranges. Furthermore, the pressure drop for elongated bubble flow is evaluated in the same manner as for slug flow, with the liquid holdup in the liquid slug taken as 1. Thus, in the fuzzy inference system, elongated bubble was included in the slug flow identification.

To simplify the programming of the fuzzy inference system, the rules are defined in decade increments in superficial velocities, up to 1000 m/s. However, the mechanistic models do not account for any supersonic physics. Thus, the ranges plotted are up to only 300 m/s. Even 300 m/s is typically unrealistically high for the liquid superficial velocity, which is usually cut off at 10 m/s in mechanistic plots, consistent with the range of existing experiments.

The right sides of FIG. 24 through FIG. 26 show the regime maps predicted by the fuzzy inference system. The agreement in regime identification is generally quite good. For vertical upward flow (θ=+90°) shown in FIG. 24, all of the transitions are in the expected sequence, from bubbly to slug to churn to annular as v_{SG} increases for a fixed value of v_{SL}. Some regime boundaries are shifted as a result of the fuzzy nature of the system.

The most notable regime boundary shifts are observed in the horizontal (θ=0°) map, shown in FIG. 25. The shifts in regime boundaries on the horizontal map are attributable to the high sensitivity of regime identification for near-horizontal angles. For slightly-upward inclined flow, slug dominates the map at low to moderate superficial velocity combinations, whereas for slightly-downward inclined flow, stratified wavy dominates the map at low to moderate v_{SG} and v_{SL}.

The FIS rarely predicts completely unexpected regimes. Only for a small portion of the downward (θ=−90°) map does a regime (stratified wavy) appear in the fuzzy prediction that does not appear on the mechanistic map.

Comparison of Fuzzy Predictions with Mechanistic Expectations for Maps not Used to Build Membership Functions and Rules.

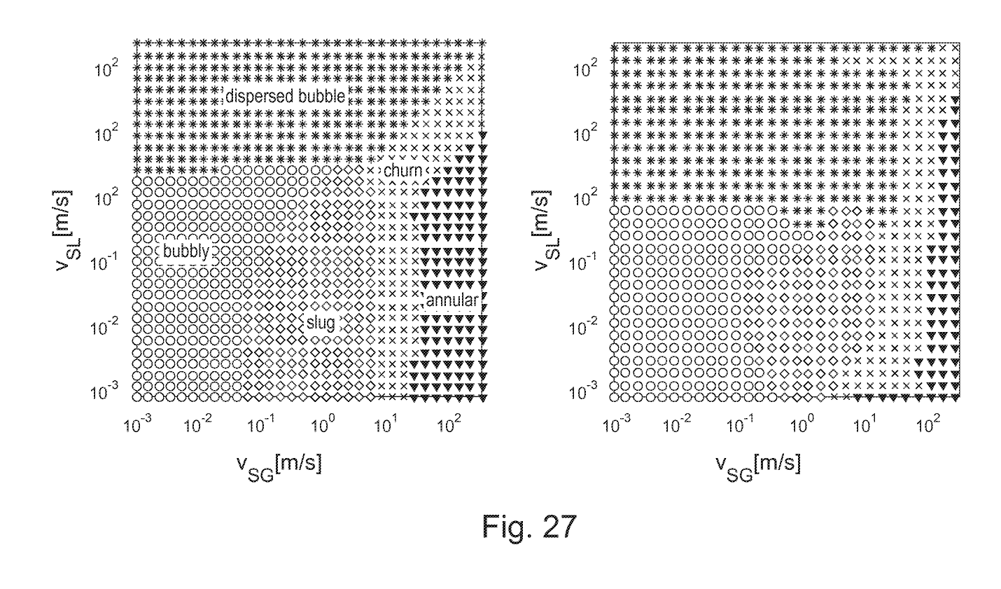

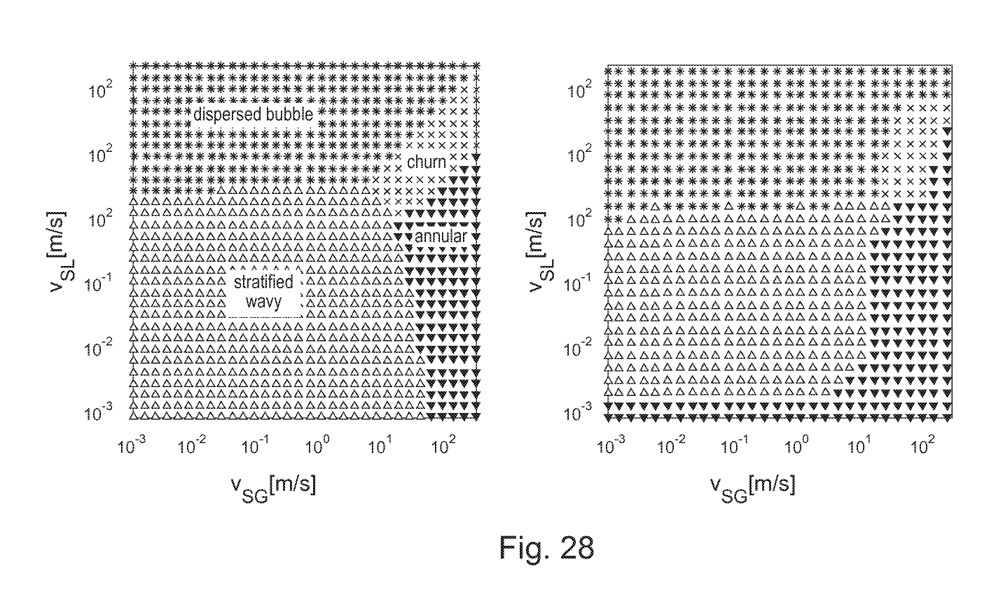

A more relevant test of the fuzzy inference system is for angles not used to build the rules. FIG. 27 and FIG. 28 provide such a test, for θ=45° and θ=−45°, respectively.

FIG. 27 illustrates a mechanistic and fuzzy regime map prediction for θ=45° (inclined upward flow) of air and water at 20° C. and 1 atm in 0.1 m diameter smooth pipe, according to various embodiments. FIG. 28 illustrates a mechanistic and fuzzy regime map prediction for θ=−45° (inclined downward flow) of air and water at 20° C. and 1 atm in 0.1 m diameter smooth pipe, according to various embodiments. Mechanistic maps of the expected regimes are shown on the left of each figure, and fuzzy maps of the predicted regimes are shown on the right. The agreement is quite good, with all major trends captured, and no spurious regimes appearing.

Pressure Drop Prediction.

After applying a defuzzification operation, the fuzzy outputs are transformed into quantifiable crisp outputs, φᵢ, for all possible regimes, i. These crisp outputs identify the equilibrium flow regime associated with the input parameters, and the proximity to adjacent and neighboring flow regimes. The highest value of the crisp outputs, φₖ≡φₘₐₓ, indicates the equilibrium flow regime, k, identified for a set of input parameters. The smaller values of the crisp outputs φⱼ, indicate the proximity of adjacent and neighboring flow regimes j, where j≠k.

Pressure drop functions corresponding to the different flow regimes at equilibrium conditions are derived from the momentum equations for the two phases. In the unlikely event in which the maximum crisp output value is identical for two regimes, the dominance is assigned in the order DB, SW, SS, SL, CH, BY, then AN, from most to least dominant. This order is largely arbitrary.

Pressure Drop for Regimes Predicted by the Mechanistic Model and Fuzzy System at Transitions.

FIG. 24 shows the regime maps predicted by the mechanistic model (left) and fuzzy system (right) in v_{SG}-v_{SL} space for vertical upward flow of air and water at 20° C. and 1 atmosphere in a smooth pipe with diameter 0.1 m. As a demonstration of the prediction provided by the fuzzy system, consider a fixed superficial liquid velocity, v_{SL}=0.1 m/s, with the superficial gas velocity v_{SG} varied from 10⁻³ to 300 m/s. This range involves transitions from bubbly to slug, then to chum, then to annular.

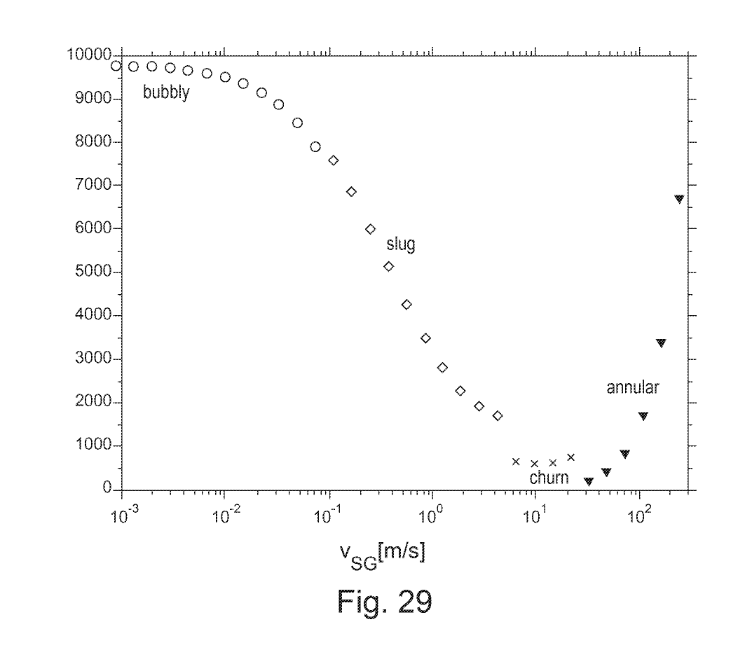

FIG. 29 illustrates discrete pressure drop values for regimes predicted by the mechanistic model for the flow of air and water at 20° C. and 1 atm in a 0.1 m diameter smooth pipe inclined vertically upward at θ=90°, for v_{SL}=0.1 meter per second (m/s), according to various embodiments. This figure shows the pressure drop predictions from the mechanistic model.

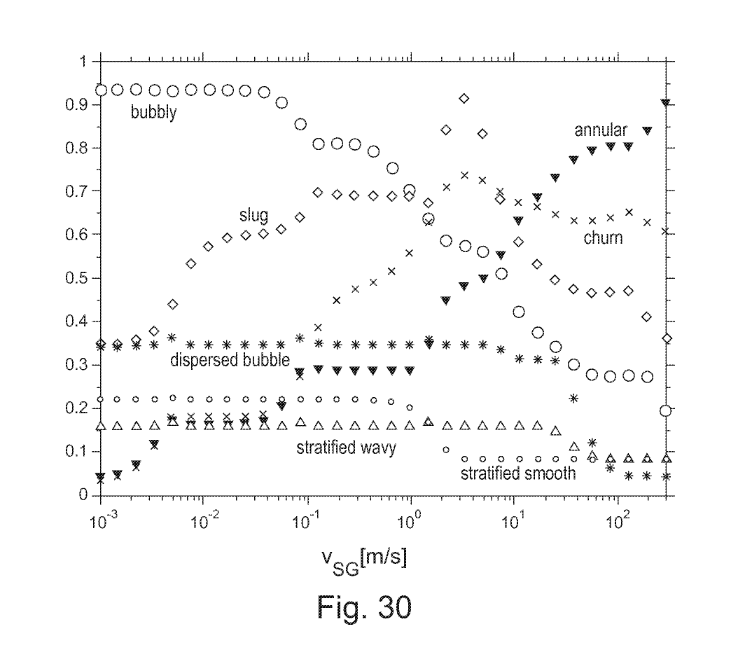

FIG. 30 illustrates crisp outputs from the fuzzy system for the flow of air and water at 20° C. and 1 atm in a 0.1 m diameter smooth pipe inclined vertically upward at θ=90°, for v_{SL}=0.1, according to various embodiments. This figure shows the crisp outputs φᵢ for the seven regimes identified by the fuzzy system. Each of the four equilibrium regimes that exist for v_{SL}=0.1 m/s appear as the equilibrium regime at some v_{SG}, as indicated by the largest crisp output value at each v_{SG}. However, the dominance of each equilibrium regime varies. For example, φ_{CH} reaches a maximum of only 0.7 in the range in which churn is the equilibrium regime, whereas φ_{BY}, φ_{SL}, and φ_{AN} all attain values near or above 0.9. This is typical of a fuzzy system, and the crisp outputs will vary based on the number and discretization of the maps used for training. Dispersed bubble is adjacent to bubbly, slug, and chum, and is a non-adjacent neighbor to annular on this map, shown in FIG. 24; consequently, it has a moderate crisp output value over most of the range of v_{SG}. In contrast, stratified smooth and stratified wavy, which are not present for any v_{SG}-v_{SL} combination at θ=90° and do not appear as equilibrium regimes until very shallow inclination angles, have relatively small values of crisp outputs over the range of v_{SG}.

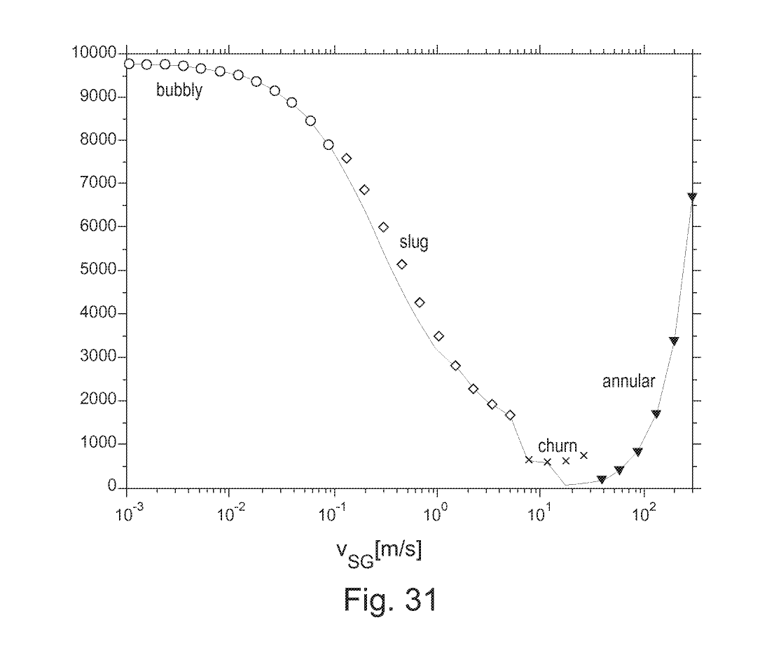

FIG. 31 illustrates pressure drop values for regimes predicted by the fuzzy system compared with discrete values for regimes predicted by the mechanistic regime model for the flow of air and water at 20° C. and 1 atm in a 0.1 m diameter smooth pipe inclined vertically upward at θ=90°, for v_{SL}=0.1 m/s, according to various embodiments. This figure shows the pressure drop for regimes identified by the fuzzy inference system (black line) along with discrete points for regimes identified by the mechanistic model for v_{SL}=0.1 m/s, over the full range of v_{SG} values. When the fuzzy system correctly identifies the regime, the pressure drop predicted by each method is exactly the same because the pressure drop equations are unique to the regime.

There are two regions in which the fuzzy system does not correctly predict the regime, as shown by the divergence of the black line from the discrete points. For 0.13 m/s≦v_{SG}≦1.0 nm/s, the fuzzy system predicts bubbly flow, rather than slug, the former of which has a lower pressure drop. In addition, for 17.2 m/s≦v_{SG}≦25.8 m/s, the fuzzy system predicts annular flow, rather than churn, the former of which has a lower pressure drop. These errors result from the discretization used to train the fuzzy inference system. If a finer discretization or more membership functions are used, the regime identification would be improved. To make an analogy with a vertical wellbore, the v_{SG} in FIG. 31 can be thought of as representing the vertical height, measured from the bottom of the well. At the bottom, the production fluids are almost completely liquid. As the fluids flow up the wellbore, the overall pressure is reduced and more gas can escape the liquid, indicated by increasing v_{SG}. After enough gas is released, the bubbly flow transitions to slug, then churn, then annular flow, for a sufficiently long wellbore with sufficient dissolved gas at the bottom hole. Thus, although large errors can be observed in the pressure drop predictions by the fuzzy system at a few locations along the vertical wellbore, the overall fuzzy system predictions are quite reasonable.

### Overall Summary of the Detailed Description and Examples 1 Through 4

In summary, using the apparatus, systems, and methods disclosed herein may provide improved computational efficiency and reliability, since a more efficient and inherently smoother mechanism is used to identify and control system responses to regime transition functions. This capability in turn serves to improve the speed and reliability of simulators and control systems, especially when discontinuities are present. These advantages can significantly enhance the value of the services provided in many industries, including those provided by an operation/exploration company or an oilfield service company, increasing customer satisfaction.

The accompanying drawings that form a part hereof, show by way of illustration, and not of limitation, specific embodiments in which the subject matter may be practiced. The embodiments illustrated are described in sufficient detail to enable those skilled in the art to practice the teachings disclosed herein. Other embodiments may be utilized and derived therefrom, such that structural and logical substitutions and changes may be made without departing from the scope of this disclosure. This Detailed Description, therefore, is not to be taken in a limiting sense, and the scope of various embodiments is defined only by the appended claims, along with the full range of equivalents to which such claims are entitled.

Such embodiments of the inventive subject matter may be referred to herein, individually and/or collectively, by the term “invention” merely for convenience and without intending to voluntarily limit the scope of this application to any single invention or inventive concept if more than one is in fact disclosed. Thus, although specific embodiments have been illustrated and described herein, it should be appreciated that any arrangement calculated to achieve the same purpose may be substituted for the specific embodiments shown. This disclosure is intended to cover any and all adaptations or variations of various embodiments. Combinations of the above embodiments, and other embodiments not specifically described herein, will be apparent to those of skill in the art upon reviewing the above description.

Although specific embodiments have been illustrated and described herein, it will be appreciated by those of ordinary skill in the art that any arrangement that is calculated to achieve the same purpose may be substituted for the specific embodiments shown. Various embodiments use permutations or combinations of embodiments described herein. It is to be understood that the above description is intended to be illustrative, and not restrictive, and that the phraseology or terminology employed herein is for the purpose of description. Combinations of the above embodiments and other embodiments will be apparent to those of ordinary skill in the art upon studying the above description.

What is claimed is:

1. A method comprising:
identifying one or more fluid flow regimes as an output of fuzzy logic processing, with inputs to the fuzzy logic processing comprising a set of physical parameter values as attributes at a location in a fluid flow that are determined by at least one of measurement or simulation; and
operating a controlled device based on the output.

2. The method of claim 1, wherein the one or more fluid flow regimes comprise at least one of a two-phase flow regime, a three-phase flow regime, or a four-phase flow regime.

3. The method of claim 2, wherein the two-phase flow regime comprises at least one of a liquid-liquid flow, a gas-solid flow, a liquid-solid flow, or a gas-liquid flow, the gas-liquid flow including at least one of a quiescent mixture, a single-phase gas, a single-phase liquid, a dispersed bubble regime, a stratified smooth regime, a stratified wavy regime, an annular regime, a slug regime, a churn regime, an elongated bubble regime, or a bubbly regime.

4. (canceled)

5. The method of claim 2, wherein:
the fluid flow for the two-phase flow regime occurs in at least one of an annulus, a channel, a conduit, or a duct having a non-circular cross-section;
the fluid flow for the three-phase flow regime occurs in at least one of a non-circular pipe, an annulus, or a channel; and
the fluid flow for the four-phase flow regime occurs in at least one of a conduit, an annulus, or a channel.

6. The method of claim 2, wherein the three-phase flow regime comprises at least one of a liquid-liquid-liquid flow, a gas-liquid-solid flow, a liquid-liquid-solid flow, or a gas-liquid-liquid flow, the gas-liquid-liquid flow including at least one of a stratified smooth, stratified wavy, or emulsion of liquid in combination with a gas-liquid regime.

7. (canceled)

8. (canceled)

9. The method of claim 2, wherein the four-phase flow regime comprises a liquid-liquid-liquid-solid flow, a gas-gas-liquid-solid flow, a liquid-liquid-solid-solid flow, or a gas-liquid-liquid-solid flow, gas-liquid-liquid-solid flow including at least one of a plurality of gas-liquid-liquid flow regimes with solids loading.

10. (canceled)

11. (canceled)

12. The method of claim 1, wherein the fluid flow comprises a contained fluid flow that occurs within a pipe, a conduit, a fluidized bed container, or a well bore of a geological formation.

13. The method of claim 1, wherein the location comprises an access port in a pipeline.

14. The method of claim 1, wherein the fuzzy logic processing comprises at least one selected from the group consisting of:
operating a fuzzy inference engine according to logical statements comprising fuzzy operations on the physical parameter values to determine a mapping of the physical parameter values within defined membership functions; and
receiving results of one of a heat transfer analysis or a vibration analysis, either real or simulated, to form a part of the inputs.

15. (canceled)

16. (canceled)

17. The method of claim 1, further comprising:
calculating a pressure drop value accounting for proximity of neighboring regimes at the location, based on the output; and
operating the controlled device based on at least the pressure drop value accounting for proximity of neighboring regimes.

18. The method of claim 1, further comprising:
determining proximity to fluid flow regime transition zones based on the identified fluid flow regimes; and
operating the controlled device to include initiating an alarm signal based on the proximity.

19. A control system, comprising:
at least one fluid parameter measurement device to provide a measured value of at least one attribute of a fluid or of the fluid's flow, at a location within a flow of the fluid;
a processing unit to identify one or more fluid flow regimes as an output of fuzzy logic processing, with the measured value of the at least one attribute as an input to the fuzzy logic processing; and
a controlled device to operate in response to at least one of the output, or to a pressure drop value accounting for proximity of nearby-neighboring regimes based on the output.

20. The system of claim 19, further comprising:
at least one of a pipe, an annulus, a conduit, a downhole logging tool, or a fluidized bed container attached to the fluid parameter measurement device; and
at least one valve or a pump electrically coupled to the processing unit, the valve or the pump comprising at least part of the controlled device to control the flow of the fluid.

21. (canceled)

22. (canceled)

23. The system of claim 19, wherein the at least one fluid parameter measurement device comprises one or more of a density measurement device, a pressure measurement device, a flow rate measurement device, or a temperature measurement device.

24. The system of claim 19, further comprising:
a wireline probe attached to the fluid parameter measurement device, wherein the controlled device is to be operated to avoid identified ones of dispersed bubble or bubbly flows as part of the one or more fluid flow regimes, in favor of single-phase liquid flow, to reduce the release of gas from liquid oil in the well.

25. The system of claim 19, further comprising:
a drill string attached to the fluid parameter measurement device, wherein the controlled device is operated to avoid identified ones of bubble, slug, or churn flows as part of the one or more fluid flow regimes, to be in favor of annular or single-phase gas flows, and to reduce water cut in a gas well during drilling operations.

26. The system of claim 19, wherein the controlled device is at least one of an electrical device or a mechanical device, and the controlled device is operated to maintain identification of a selected one of the one or more fluid flow regimes within the flow of the fluid.

27. The system of claim 19, wherein the controlled device comprises at least one selected from the group consisting of:
a slug catcher to be activated when the one or more fluid flow regimes includes a slug flow regime;
a pump that is to be operated to avoid identified ones of bubbly or slug flows as part of the one or more fluid flow regimes, in favor of dispersed bubble or single-phase liquid flows, to reduce probability of gas locking in an oil well;
a sucker rod that is to be operated to avoid identified ones of bubbly, slug, elongated bubble, or chum flows as part of the one or more fluid flow regimes, in favor of dispersed bubble or single-phase liquid flows in an oil well;
a separator that is to be operated to avoid identified ones of intermittent slug, elongated bubble, or chum flows as part of the one or more fluid flow regimes, in favor of stratified smooth or stratified wavy flows, to reduce dwell time in the separator; and
a downhole inflow control device that is to be operated to avoid identified annular flow as part of the one or more fluid flow regimes, in favor of single-phase gas flow in a gas well to reduce water production.

28. (canceled)

29. (canceled)

30. (canceled)

31. (canceled)

32. The system of claim 19, wherein the location at which the at least one attribute is measured is within a fluid conduit coupled to the at least one fluid parameter measurement device, and the system further comprises a monitor to provide at least one selected from the group consisting of:
an erosion signal for the fluid conduit due to particulate transport when the output indicates that a transition to an intermittent regime, identified as part of the one or more fluid regimes, has not been avoided in favor of a stratified wavy regime or a stratified smooth regime;
a particulate deposition signal for the fluid conduit when the output indicates that the stratified wavy regime or the stratified smooth regime has not been avoided in favor of the intermittent regime;
a signal to indicate onset of emulsion flow in a liquid-liquid flow, to be avoided by reducing a flow rate so as to allow easier separation of produced liquid components;
a signal to indicate onset of slug flow in a gas-liquid-liquid-solid flow, to be avoided in favor of stratified flow so as to reduce water production and erosion by solid particles in a pipeline;
a signal to indicate an intermittent multiphase flow regime, to be avoided in favor of annular flow so as to reduce heat transfer from production fluids in a wellbore;
a signal indicating an undesired transition from a first one of the fluid flow regimes to a second one of the fluid flow regimes; and
a signal indicating proximity to the intermittent regime as a prelude to a system failure mode.

33. (canceled)

34. (canceled)

35. (canceled)

36. (canceled)

37. (canceled)

38. (canceled)

39. The system of claim 32, wherein the controlled device is operated to avoid the intermittent regime in response to the signal indicating proximity to the intermittent regime.
